(19) United States
(12) Patent Application Publication
(10) Pub. No.: US 2008/0293539 A1
(43) Pub. Date: Nov. 27, 2008

(54) Control apparatus for vehicular drive system

(75) Inventors: Tooru Matsubara, Toyota-shi (JP); Atsushi Tabata, Okazaki-shi (JP); Masakazu Kaifuku, Okazaki-shi (JP)

Correspondence Address: OLIFF & BERRIDGE, PLC, P.O. BOX 320850, ALEXANDRIA, VA, 22320-4850, US

(73) Assignee: TOYOTA JIDOSHA KABUSHIKI KAISHA, Toyota-shi (JP)

(21) Appl. No.: 12/153,355

(22) Filed: May 16, 2008

(30) Foreign Application Priority Data
May 24, 2007 (JP) 2007-137498

(51) Int. Cl. B60W 10/04

(52) U.S. Cl. 477/37

(57) ABSTRACT

A control apparatus for a vehicular drive system including (a) a first drive power source, (b) an electrically controlled differential portion which has a differential mechanism and a second drive power source connected to a rotary element of the differential mechanism and which is operable to control a differential state between a rotating speed of its input shaft connected to the first drive power source and a rotating speed of its output shaft by controlling an operating state of the second drive power source, (c) a switching portion operable to switch a power transmitting path between the electrically controlled differential portion and a drive wheel of a vehicle, between a power transmitting state and a power cut-off state, and (d) a third drive power source operatively connected to the power transmitting path, the control apparatus including a power-source torque-variation reducing portion configured to reduce an amount of variation of a torque of the first drive power source or the third drive power source upon switching of the power transmitting path from the power cut-off state to the power transmitting state.

### CROSS REFERENCE TO RELATED APPLICATION

The present application claims priority from Japanese Patent Application No. 2007-137498, which was filed on May 24, 2007, the disclosure of which is herein incorporated by reference in its entirety.

### BACKGROUND OF THE INVENTION

1. Field of the Invention

The present invention relates in general to a control apparatus for a vehicular drive system, and more particularly to techniques for reducing a switching shock which would take place upon switching of a hybrid-type vehicular drive system including a differential mechanism, from a power cut-off state to a power transmitting state.

2. Discussion of Prior Art

There is known a vehicular drive system including (a) an engine, (b) an electrically controlled differential portion which has a differential mechanism and a first electric motor connected to a rotary element of the differential mechanism and which is operable to control a differential state between rotating speeds of its input shaft connected to the engine and a rotating speed of its output shaft by controlling an operating state of the first electric motor, and (c) a second electric motor connected to a power transmitting path between the electrically controlled differential portion and a drive wheel of a vehicle. JP-2005-264762A discloses an example of a control apparatus for such a vehicular drive system. The control apparatus disclosed in this publication is configured to rapidly raise the operating speed of the engine to a value permitting ignition of the engine, by operating the first electric motor and the second electric motor in the same direction, for thereby starting the engine.

The hybrid-type vehicular drive system as disclosed in the above-identified publication tends to suffer from a variation of an input torque of the power transmitting path due to a variation of an output torque of the engine upon starting of the engine upon switching of the power transmitting path from the power cut-off state to the power transmitting state. Accordingly, the rotating speed of the output shaft of the differential mechanism and the operating speed of the second electric motor tend to vary, giving rise to a risk of a large amount of engaging shock of frictional coupling devices such as clutches provided in the power transmitting path.

### SUMMARY OF THE INVENTION

The present invention was made in view of the background art described above. It is therefore an object of this invention to provide a control apparatus configured to reduce a switching shock which would take place upon switching of a power transmitting path from a power cut-off state to a power transmitting state in a vehicular drive system including (a) a first drive power source, (b) an electrically controlled differential portion which has a differential mechanism and a second drive power source connected to a rotary element of the differential mechanism and which is operable to control a differential state between a rotating speed of its input shaft connected to the first drive power source and a rotating speed of its output shaft by controlling an operating state of the second drive power source, and (c) a switching portion operable to switch the power transmitting path between the electrically controlled differential portion and a drive wheel of a vehicle, between the power transmitting state and the power cut-off state.

The object indicated above can be achieved according to any one of the following modes of this invention, each of which is numbered like the appended claims and which depends from the other mode or modes, where appropriate, for easier understanding of technical features disclosed in the present application, and combinations of those features.

(1) A control apparatus for a vehicular drive system including (a) a first drive power source, (b) an electrically controlled differential portion which has a differential mechanism and a second drive power source connected to a rotary element of the differential mechanism and which is operable to control a differential state between a rotating speed of its input shaft connected to the first drive power source and a rotating speed of its output shaft by controlling an operating state of the second drive power source, and (c) a switching portion operable to switch a power transmitting path between the electrically controlled differential portion and a drive wheel of a vehicle, between a power transmitting state and a power cut-off state, the control apparatus comprising a first-power-source torque-variation reducing portion configured to reduce an amount of variation of a torque of the first drive power source upon switching of the power transmitting path from the power cut-off state to the power transmitting state.

In the control apparatus of the above-described mode (1) according to a first aspect of the present invention, the first-power-source torque variation reducing portion is provided to reduce the amount of variation of the torque of the first drive power source when the power transmitting path is switched from the power cut-off state to the power transmitting state, so that an amount of variation of the rotating speed of the output shaft of the electrically controlled differential portion due to the torque variation of the first drive power source upon switching of the power transmitting path from the power cut-off state to the power transmitting state can be effectively reduced, and a switching shock of the power transmitting path can be reduced.

(2) The control apparatus according to the above-described mode (1), wherein the first-power-source torque-variation reducing portion is configured to reduce the amount of variation of the torque of the first drive power source from a target value.

In the above-described mode (2) of the present invention, the amount of variation of the torque of the first drive power source from the target value is reduced, so that an amount of variation of the rotating speed of the output shaft (18) of the electrically controlled differential portion (11) due to the torque variation of the first drive power source upon switching of the switching of the power transmitting path can be effectively reduced, and the switching shock of the power transmitting path can be reduced.

(3) The control apparatus according to the above-described mode (2), wherein the first-power-source torque-variation reducing portion is configured to permit a control of a vehicle drive force produced by the first drive power source in the process of the switching of the power transmitting path.

In the above-described mode (3) of this invention, the control of the vehicle drive force produced by the first drive power source is permitted by the first-power-source torque-variation reducing portion even in the process of the switching of the power transmitting path, so that the torque of the first drive power source is controlled to the target value while the amount of the torque variation of the first drive power source is reduced.

(4) The control apparatus according to any one of the above-described modes (1)-(3), wherein the first-power-source torque-variation reducing portion is configured to inhibit a control of the vehicular drive system which is implemented depending upon a running state of the vehicle and which causes a torque variation of the vehicular drive system.

In the above-described mode (4), a control of the vehicular drive system which is implemented depending upon the running state of the vehicle and which causes the torque variation of the vehicular drive system is inhibited, so that the amount of the torque variation of the vehicular drive system can be reduced, and the switching shock of the power transmitting path can be reduced.

(5) The control apparatus according to the above-described mode (4), wherein the first-power-source torque-variation reducing portion is configured to permit continuation of a control of the vehicular drive system that causes a torque variation of the vehicular drive system if the above-indicated control has already been initiated prior to an operation of the first-power-source torque-variation reducing portion.

In the above-described mode (5) of the present invention, the control of the vehicular drive system that causes a torque variation of the vehicular drive system is v permitted by the first-power-source torque-variation reducing portion to be continued if this control has already been initiated prior to an operation of the first-power-source torque-variation reducing portion. The continuation of the control makes it possible to prevent the torque variation of the vehicular drive system which would otherwise take place due to stopping of the control in the process of the switching of the power transmitting path from the power cut-off state to the power transmitting state.

(6) The control apparatus according to the above-described mode (4) or (5), wherein the above-indicated control of the vehicular drive system which is implemented depending upon the running state of the vehicle and which causes the torque variation of the vehicular drive system is at least one of a starting control of the first drive power source, a stopping control of the first drive power source, a charging control of an electric-energy storage device by an electric generator connected to the first drive power source, and a discharging control of the electric-energy storage device.

In the above-described mode (6), at least one of the starting and stopping controls of the first drive power source, and the charging and discharging controls of the electric-energy storage device is inhibited in the process of the switching of the power transmitting path from the power cut-off state to the power transmitting state, so that the amount of variation of the torque of the first drive power source can be reduced.

(7) The control apparatus according to any one of the above described modes (4)-(6), wherein the first-power-source torque-variation reducing portion is configured not to inhibit the above-indicated control of the vehicular drive system which is implemented depending upon the running state of the vehicle and which causes the torque variation of the vehicular drive system, if a predetermined operation is performed by an operator of the vehicle.

In the above-described mode (7) of the invention, when the vehicle operator operates an accelerator pedal, desiring to accelerate the vehicle, for example, rapid switching of the power transmitting path from the power cut-off state to the power transmitting state for accelerating the vehicle is more important than reduction of the switching shock. In this case, the first-power-source torque-variation reducing portion does not inhibit the above-indicated control of the vehicular drive system.

(8) The control apparatus according to the above-described mode (7), wherein the above-indicated predetermined operation performed by the operator of the vehicle is an operation of a vehicle accelerating member to accelerate the vehicle or an operation of a brake operating member.

In the above-described mode (8) of the present invention, the above-indicated control of the vehicular drive system is not inhibited if the vehicle accelerating member or brake operating member is operated by the vehicle operator, so that the vehicle is accelerated or braked as desired by the vehicle operator. When the vehicle accelerating member in the form of an accelerator pedal is operated by more than a predetermined amount, the vehicle is rapidly accelerated as a result of the operation of the accelerator pedal. When the vehicle braking member in the form of a brake pedal is operated, the vehicle is rapidly decelerated as a result of the operation of the brake pedal.

(9) The control apparatus according to any one of the above-described modes (4)-(8), wherein the first-power-source torque-variation reducing portion is configured not to inhibit the control of the vehicular drive system which is implemented depending upon the running state of the vehicle and which causes the torque variation of the vehicular drive system, if the running state of the vehicle satisfies a predetermined condition.

In the above-described mode (9), the above-indicated control of the vehicular drive system is implemented if the running state of the vehicle satisfies a predetermined condition. In this case, the control that causes the torque variation of the vehicular drive system is more important than reduction of the switching shock.

(10) The control apparatus according to the above-described mode (9), wherein the running state of the vehicle which satisfies the predetermined condition is a running speed of the vehicle higher than a predetermined threshold, a hydraulic pressure of the switching portion outside a predetermined range, or a drive force larger than a predetermined threshold, which is generated by the first drive power source

In the above-described mode (10), the above-indicated control of the vehicular drive system is implemented if the vehicle running speed is higher than the predetermined threshold, if the hydraulic pressure of the switching portion is outside the predetermined range, or if the drive force generated by the first drive power source is larger than the predetermined threshold. In this case, the control that causes the torque variation of the vehicular drive system is more important than reduction of the switching shock.

(11) The control apparatus according to any one of the above-described modes (1)-(10), wherein the electrically controlled differential portion is operable as a continuously-variable transmission mechanism when the operating state of said second drive power source is controlled.

In the above-described mode (11) wherein the electrically controlled differential portion is operable as the continuously-variable transmission mechanism when the operating state of the second drive power source is controlled, the vehicle drive torque can be smoothly changed. It is noted that the electrically controlled differential portion is operable not only as an electrically controlled continuously-variable transmission the speed ratio of which is continuously variable, but also as a step-variable transmission the speed ratio of which is variable in steps, so that an overall speed ratio of the vehicular drive system can be rapidly changed in steps, whereby the vehicle drive torque can be rapidly changed.

(12) The control apparatus according to the above-described modes (1)-(11), wherein the first drive power source is an engine.

In the above-described mode (12), the amount of variation of the torque of the engine can be effectively reduced by the first-power-source torque-variation reducing portion.

(13) The control apparatus according to any one of the above-described modes (1)-(12), wherein the second drive power source is a first electric motor operated with an electric energy.

In the above-described mode (13) of this invention, the operating state of the electrically controlled differential portion is suitably controlled by controlling the first electric motor.

(14) A control apparatus for a vehicular drive system including (a) a first drive power source, (b) an electrically controlled differential portion which has a differential mechanism and a second drive power source connected to a rotary element of the differential mechanism and which is operable to control a differential state between a rotating speed of its input shaft connected to the first drive power source and a rotating speed of its output shaft by controlling an operating state of the second drive power source, (c) a switching portion operable to switch a power transmitting path between the electrically controlled differential portion and a drive wheel of a vehicle, between a power transmitting state and a power cut-off state, and (d) a third drive power source operatively connected to a portion of the power transmitting path, the control apparatus comprising a third-power-source torque-variation reducing portion configured to reduce an amount of variation of a torque of the third drive power source upon switching of the power transmitting path from the power cut-off state to the power transmitting state.

In the control apparatus of the above-described mode (14) according to a second aspect of the present invention, the third-power-source torque-variation reducing portion is provided to reduce the amount of variation of the torque of the third drive power source when the power transmitting path is switched from the power cut-off state to the power transmitting state, so that an amount of variation of the rotating speed of the output shaft of the electrically controlled differential portion due to the torque variation of the third drive power source upon switching of the power transmitting path from the power cut-off state to the power transmitting state can be effectively reduced, and a switching shock of the power transmitting path can be reduced.

(15} The control apparatus according to the above-described mode (14), wherein the third-power-source torque-variation reducing portion is configured to permit continuation of a control of the vehicular drive system that causes a torque variation of the vehicular drive system if the above-indicated control has already been initiated prior to an operation of the third-power-source torque-variation reducing portion.

In the above-described mode (15) of the present invention, the control of the vehicular drive system that causes a torque variation of the vehicular drive system is permitted by the third-power-source torque-variation reducing portion to be continued if this control has already been initiated prior to an operation of the third-power-source torque-variation reducing portion. The continuation of the control makes it possible to prevent the torque variation of the vehicular drive system which would otherwise take place due to stopping of the control in the process of the switching of the power transmitting path from the power cut-off state to the power transmitting state.

(16) The control apparatus according to the above-described mode (15), wherein the third-power-source torque-variation reducing portion is configured to permit a control of a drive force produced by the third drive power source in the process of the switching of the power transmitting path.

In the above-described mode (16), the torque of the third drive power source is controlled to a target value while the amount of variation of the torque is reduced.

(17) The control apparatus according to the above-described mode (15) or (16), wherein the third-power-source torque-variation reducing portion is configured to permit continuation of a control of the vehicular drive system that causes a torque variation of the vehicular drive system if said control has already been initiated prior to an operation of the first-power-source torque-variation reducing portion.

The above-described mode (17) has the same advantage as described above with the above-described mode (5).

(18) The control apparatus according to any one of the above-described modes (15)-(17), wherein the above-indicated control of the vehicular drive system which is implemented depending upon the running state of the vehicle and which causes the torque variation of the vehicular drive system is at least one of a starting control of the first drive power source, a stopping control of the first drive power source, a charging control of an electric-energy storage device by an electric generator connected to the first drive power source, and a discharging control of the electric-energy storage device.

The above-described mode (18) has the same advantage as described above with respect to the above-described mode (6).

(19) The control apparatus according to any one of the above-described modes (15)-(18), wherein the third-power-source torque-variation reducing portion is configured not to inhibit the control of the vehicular drive system which is implemented depending upon the running state of the vehicle and which causes the torque variation of the vehicular drive system, if a predetermined operation is performed by an operator of the vehicle.

The above-described mode (19) has the same advantage as described above with respect to the above-described mode (7).

(20) The control apparatus according to the above-described mode (19), wherein the above-indicated predetermined operation performed by the operator of the vehicle is an operation of a vehicle accelerating member to accelerate the vehicle or an operation of a brake operating member.

The above-described mode (20) has the same advantage as described above with respect to the above-described mode (8).

(21) The control apparatus according to any one of the above-described modes (15)-(20), wherein the third-power-source torque-variation reducing portion is configured not to inhibit the control of the vehicular drive system which is implemented depending upon the running state of the vehicle and which causes the torque variation of the vehicular drive system, if the running state of the vehicle satisfies a predetermined condition.

The above-described mode (21) has the same advantage as described above with respect to the above-described mode (9).

(22) The control apparatus according to the above-described mode (21), wherein the running state of the vehicle which satisfies the predetermined condition is a running speed of the vehicle higher than a predetermined threshold, a hydraulic pressure of the switching portion outside a predetermined range, or a drive force larger than a predetermined threshold, which is generated by the first drive power source.

The above-described mode (22) has the same advantage as described above with respect to the above-described mode (10).

(23) The control apparatus according to any one of the above-described modes (14)-(22), wherein the electrically controlled differential portion is operable as a continuously-variable transmission mechanism when the operating state of said second drive power source is controlled.

The above-described mode (23) has the same advantage as described above with respect to the above-described mode (11).

(24) The control apparatus according to any one of the above-described modes (14)-(23), wherein the first drive power source is an engine.

In the above-described mode (24), the amount of variation of the torque of the engine can be reduced by a first-power-source torque-variation reducing portion described above with respect to the above-described first mode (1).

(25) The control apparatus according to any one of the above-described modes (14)-(24), wherein the second drive power source is a first electric motor operated with an electric energy.

The above-described mode (25) has the same advantage as described above with respect to the above-described mode (13).

(26) The control apparatus according to any one of the above-described modes (14)-(25), wherein the third drive power source is a second electric motor operated with an electric energy.

In the above-described mode (26) of this invention, the amount of variation of the torque of the second electric motor can be effectively reduced by the third-power-source torque-variation reducing portion.

(27) A control apparatus for a vehicular drive system including (a) a first drive power source, (b) a switching portion operable to switch a power transmitting path between the first drive power source and a drive wheel of a vehicle, between a power transmitting state and a power cut-off state, and (c) an electric motor operatively connected to a portion of the power transmitting path, the control apparatus comprising an electric-motor torque-variation reducing portion configured to reduce an amount of variation of the electric motor upon switching of the power transmitting path from the power cut-off state to the power transmitting state.

In the control apparatus of the above-described mode (27) according to a third aspect of the present invention, the electric-motor torque-variation reducing portion is provided to reduce the amount of variation of the torque of the electric motor when the power transmitting path is switched from the power cut-off state to the power transmitting state, so that an amount of variation of the rotating speed of the output shaft of the electrically controlled differential portion due to the torque variation of the electric motor upon switching of the power transmitting path from the power cut-off state to the power transmitting state can be effectively reduced, and a switching shock of the power transmitting path can be reduced.

(28) The control apparatus according to the above-described mode (27), wherein the electric-motor torque-variation reducing portion is configured to inhibit a control of the vehicular drive system which is implemented depending upon a running state of the vehicle and which causes a torque variation of the vehicular drive system.

In the above-described mode (28), the control of the vehicular drive system which causes the torque variation of the vehicular drive system is inhibited, so that the amount of torque variation is reduced, and the switching shock is reduced.

(29) The control apparatus according to the above-described mode (28), wherein the electric-motor torque-variation reducing portion is configured to permit a control of a drive force produced by the electric motor in the process of the switching of the power transmitting path.

In the above-described mode (29), the electric-motor torque-variation reducing portion permits the control of the drive force produced by the electric motor upon switching of the power transmitting path, so that the torque of the electric motor is controlled to a target value while the amount of variation of the torque is reduced.

(30) The control apparatus according to the above-described mode (28) or (29), wherein the electric-motor torque-variation reducing portion is configured to permit continuation of a control of the vehicular drive system that causes a torque variation of the vehicular drive system if the above-indicated control has already been initiated prior to an operation of the electric-motor torque-variation reducing portion.

In the above-described mode (30) of the present invention, the control of the vehicular drive system that causes a torque variation of the vehicular drive system is permitted by the electric-motor torque-variation reducing portion to be continued if this control has already been initiated prior to an operation of the electric-motor torque-variation reducing portion. The continuation of the control makes it possible to prevent the torque variation of the vehicular drive system which would otherwise take place due to stopping of the control in the process of the switching of the power transmitting path from the power cut-off state to the power transmitting state.

(31) The control apparatus according to any one of the above-described modes (28)-(30), wherein the above-indicated control of the vehicular drive system which is implemented depending upon the running state of the vehicle and which causes the torque variation of the vehicular drive system is at least one of a starting control of the first drive power source, a stopping control of the first drive power source, a charging control of an electric-energy storage device by an electric generator connected to the first drive power source, and a discharging control of the electric-energy storage device.

The above-described mode (31) has the same advantage as described above with respect to the above-described mode (6).

(32) The control apparatus according to any one of the above-described modes (28)-(31), wherein the electric-motor torque-variation reducing portion is configured not to inhibit the control of the vehicular drive system which is implemented depending upon the running state of the vehicle and which causes the torque variation of the vehicular drive system, if a predetermined operation is performed by an operator of the vehicle.

The above-described mode (32) has the same advantage as described above with respect to the above-described mode (7).

(33) The control apparatus according to the above-described mode (32), wherein the above-indicated predetermined operation performed by the operator of the vehicle is an operation of a vehicle accelerating member to accelerate the vehicle or an operation of a brake operating member.

The above-described mode (33) has the same advantage as described above with respect to the above-described mode (8).

(34) The control apparatus according to any one of the above-described modes (28)-(33), wherein the electric-motor torque-variation reducing portion is configured not to inhibit the control of the vehicular drive system which is implemented depending upon the running state of the vehicle and which causes the torque variation of the vehicular drive system, if the running state of the vehicle satisfies a predetermined condition.

The above-described mode (34) has the same advantage as described above with respect to the above-described mode (9).

(35) The control apparatus according to the above-described mode (34), wherein the running state of the vehicle which satisfies the predetermined condition is a running speed of the vehicle higher than a predetermined threshold, a hydraulic pressure of the switching portion outside a predetermined range, or a drive force larger than a predetermined threshold, which is generated by the first drive power source.

The above-described mode (35) has the same advantage as described above with respect to the above-described mode (10).

(36) The control apparatus according to any one of the above-described modes (28)-(35), wherein the first drive power source is an engine.

In the above-described mode (36), the amount of variation of the torque of the engine can be reduced by a first-power-source torque-variation reducing portion described above with respect to the above-described mode (1).

Preferably, the differential mechanism of the electrically controlled differential portion is a single-pinion type planetary gear set. In this case, the differential mechanism consisting of the single single-pinion type planetary gear set can be simplified in construction, and the required axial dimension of the differential mechanism can be reduced.

Preferably, the vehicular drive system has an overall speed ratio defined by a speed ratio of the electrically controlled differential portion and a speed ratio of a step-variable transmission portion which is operatively connected to the electrically controlled differential portion and which constitutes a part of the above-described power transmitting path. In this case, the vehicle drive force can be obtained over a wide range of speed ratio, by changing the speed ratio (gear ratio) of the transmission portion as well as the speed ratio of the differential portion.

### BRIEF DESCRIPTION OF THE DRAWINGS

The above and other objects, features, advantages, and technical and industrial significance of this invention will be better understood by reading the following detailed description of preferred embodiments of the present invention, when considered in connection with the accompanying drawings, in which:

FIG. 1 is a schematic view showing an arrangement of one form of a drive system for a hybrid vehicle, which is controlled by a control apparatus constructed according to a first embodiment of this invention;

FIG. 2 is a table indicating shifting actions of an automatic transmission portion provided in the drive system of FIG. 1, in relation to different combinations of operating states of hydraulically operated frictional coupling devices to effect the respective shifting actions;

FIG. 3 is a collinear chart indicating relative rotating speeds of rotary elements of a differential portion and the automatic transmission portion of the drive system of FIG. 1;

FIG. 4 is a view indicating input and output signals of an electronic control device serving as the control apparatus according to the embodiment of this invention to control the drive system of FIG. 1;

FIG. 5 is a circuit diagram showing hydraulic actuators provided in a hydraulic control unit, for operating clutches and brakes incorporated in the automatic transmission portion, and linear solenoid valves for controlling the hydraulic actuators;

FIG. 6 is a view showing an example of a manually operated shifting device including a shift lever and operable to select one of a plurality of shift positions;

FIG. 7 is a functional block diagram illustrating major control functions of the electronic control device of FIG. 4;

FIG. 8 is a view illustrating an example of a stored shifting boundary line map used for determining a shifting action of the automatic transmission portion, and an example of a stored drive-power-source switching boundary line map used for switch a vehicle drive mode between an engine drive mode and a motor drive mode, the shifting and switching boundary line maps being defined in the same two-dimensional coordinate system, in relation to each other;

FIG. 9 is a view illustrating an example of a fuel consumption map defining a highest-fuel-economy curve of an engine (indicated by broken line);

FIG. 10 is a time chart for explaining an engine starting control when a shift lever is operated from a neutral position N to a forward drive position D while an accelerator pedal is placed in its non-operated position;

FIG. 11 is a time chart for explaining an engine starting control when the shift lever is operated from the neutral position N to the forward drive position D while the accelerator pedal is placed in an operated position;

FIG. 12 is a flow chart illustrating a control routine executed by the electronic control device of FIG. 4, for reducing a variation of an input speed of the automatic transmission portion when the shift lever is operated form the neutral position to the forward drive position D; and.

FIG. 13 is a schematic view showing an arrangement of a vehicular drive system which is controlled by a control apparatus constructed according to a second embodiment of this invention.

### DETAILED DESCRIPTION OF THE PREFERRED EMBODIMENT

### First Embodiment

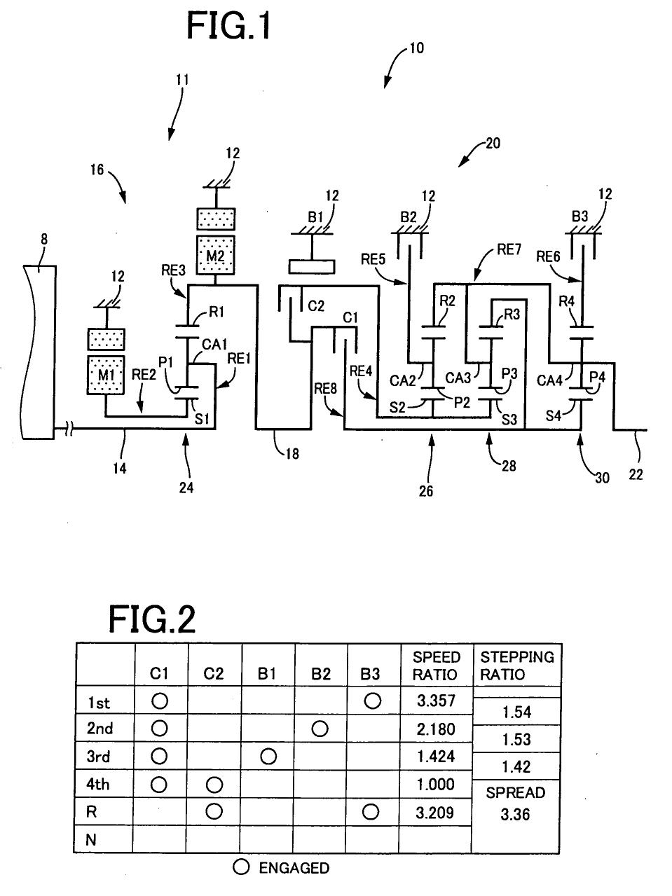

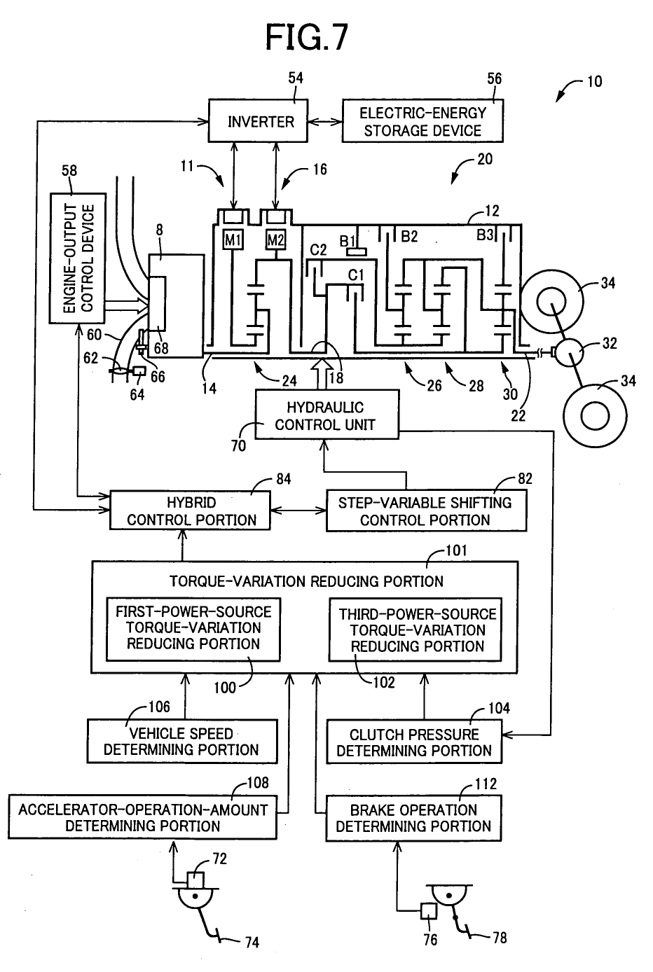

Referring first to the schematic view of FIG. 1, there is shown a transmission mechanism 10 constituting a part of a drive system for a hybrid vehicle, which drive system is controlled by a control apparatus constructed according to one embodiment of this invention. As shown in FIG. 1, the transmission mechanism 10 includes: an input rotary member in the form of an input shaft 14; a continuously-variable transmission portion in the form of a differential portion 11 connected to the input shaft 14 either directly, or indirectly via a pulsation absorbing damper (vibration damping device) not shown; a power transmitting portion in the form of a hydraulic automatic transmission portion 20 disposed between the differential portion 11 and drive wheels 34 (shown in FIG. 7) of the hybrid vehicle, and connected in series via a power transmitting member 18 (power transmitting shaft) to the differential portion 11 and the drive wheels 34; and an output rotary member in the form of an output shaft 22 connected to the automatic transmission portion 20. The input shaft 12, differential portion 11, automatic transmission portion 20 and output shaft 22 are coaxially disposed on a common axis in a transmission casing 12 (hereinafter referred to simply as “casing 12”) functioning as a stationary member attached to a body of the vehicle, and are connected in series with each other. This transmission mechanism 10 is suitably used for a transverse FR vehicle (front-engine, rear-drive vehicle), and is disposed between a drive power source in the form of an internal combustion engine 8 and the pair of drive wheels 34, to transmit a vehicle drive force from the engine 8 to the pair of drive wheels 34 through a differential gear device 32 (final speed reduction gear) and a pair of drive axles, as shown in FIG. 7. The engine 8 may be a gasoline engine or diesel engine and functions as a vehicle drive power source directly connected to the input shaft 14 or indirectly via a pulsation absorbing damper. It will be understood that the engine 8 functions as a first drive power source of the drive system.

In the present transmission mechanism 10 constructed as described above, the engine 8 and the differential portion 11 are directly connected to each other. This direct connection means that the engine 8 and the transmission portion 11 are connected to each other, without a fluid-operated power transmitting device such as a torque converter or a fluid coupling being disposed therebetween, but may be connected to each other through the pulsation absorbing damper as described above. It is noted that a lower half of the transmission mechanism 10, which is constructed symmetrically with respect to its axis, is omitted in FIG. 1. This is also true to the other embodiments of the invention described below.

The differential portion 11 is provided with: a first electric motor M1; a power distributing mechanism 16 functioning as a differential mechanism operable to mechanically distribute an output of the engine 8 received by the input shaft 14, to the first electric motor M1 and the power transmitting member 18; and a second electric motor M2 which is operatively connected to and rotated with the power transmitting member 18. Each of the first and second electric motors M1 and M2 used in the present embodiment is a so-called motor/generator having a function of an electric motor and a function of an electric generator. However, the first electric motor M1 should function at least as an electric generator operable to generate an electric energy and a reaction force, while the second electric motor M2 should function at least as a drive power source operable to produce a vehicle drive force. It will be understood that the differential portion 11 functions as an electrically controlled differential portion, and the first electric motor M1 functions as a second drive power source and a first electric motor, while the second electric motor M2 functions as a third drive power source and a second electric motor.

The power distributing mechanism 16 includes, as a major component, a first planetary gear set 24 of a single pinion type having a gear ratio ρ1 of about 0.418, for example. The first planetary gear set 24 has rotary elements consisting of: a first sun gear S1, a first planetary gear P1; a first carrier CA1 supporting the first planetary gear P1 such that the first planetary gear P1 is rotatable about its axis and about the axis of the first sun gear S1; and a first ring gear R1 meshing with the first sun gear S1 through the first planetary gear P1. Where the numbers of teeth of the first sun gear S1 and the first ring gear R1 are represented by ZS1 and ZR1, respectively, the above-indicated gear ratio ρ1 is represented by ZS1/ZR1.

In the power distributing mechanism 16, the first carrier CA1 is connected to the input shaft 14, that is, to the engine 8, and the first sun gear S1 is connected to the first electric motor M1, while the first ring gear R1 is connected to the power transmitting member 18. The power distributing mechanism 16 constructed as described above is operated in a differential state in which three elements of the first planetary gear set 24 consisting of the first sun gear S1, first carrier CA1 and first ring gear R1 are rotatable relative to each other, so as to perform a differential function. In the differential state, the output of the engine 8 is distributed to the first electric motor M1 and the power transmitting member 18, whereby a portion of the output of the engine 8 is used to drive the first electric motor M1 to generate an electric energy which is stored or used to drive the second electric motor M2. Namely, the differential portion 11 (power distributing mechanism 16) functions as an electric differential device, which is operable in a continuously-variable shifting state (electrically established CVT state) in which the rotating speed of the power transmitting member 18 is continuously variable, irrespective of the rotating speed of the engine 8, namely, placed in the differential state in which a speed ratio γ0 (rotating speed N_{IN} of the input shaft 14/rotating speed N₁₈ of the power transmitting member 18) of the differential portion 11 is continuously changed from a minimum value γ0min to a maximum value γ0max, that is, in the continuously-variable shifting state in which the differential portion 11 functions as an electrically controlled continuously-variable transmission the speed ratio γ0 of which is continuously variable from the minimum value γ0min to the maximum value γ0max. Thus, the differential portion 11 functions as a continuously-variable transmission mechanism wherein a differential state between rotating speeds of the input shaft 14 and the power transmitting member 18 is controlled by controlling the operating states of the first electric motor M1, second electric motor M2 and engine 8 that are operatively connected to the power distributing mechanism 16. It will be understood that the power distributing mechanism 16 functions as a differential mechanism while the power transmitting member 18 functions as an output shaft of the differential mechanism.

The automatic transmission portion 20 is a step-variable automatic transmission which constitutes a part of a power transmitting path between the differential portion 11 and the drive wheels 34. The automatic transmission portion 20 includes a single-pinion type second planetary gear set 26, a single-pinion type third planetary gear set 28 and a single-pinion type fourth planetary gear set 30. Thus, the automatic transmission portion 20 is a multiple-step transmission of a planetary gear type. The second planetary gear set 26 has: a second sun gear S2; a second planetary gear P2; a second carrier CA2 supporting the second planetary gear P2 such that the second planetary gear P2 is rotatable about its axis and about the axis of the second sun gear S2; and a second ring gear R2 meshing with the second sun gear S2 through the second planetary gear P2. For example, the second planetary gear set 26 has a gear ratio ρ2 of about 0.562. The third planetary gear set 28 has: a third sun gear S3; a third planetary gear P3; a third carrier CA3 supporting the third planetary gear P3 such that the third planetary gear P3 is rotatable about its axis and about the axis of the third sun gear S3; and a third ring gear R3 meshing with the third sun gear S3 through the third planetary gear P3. For example, the third planetary gear set 28 has a gear ratio ρ3 of about 0.425. The fourth planetary gear set 30 has: a fourth sun gear S4; a fourth planetary gear P4; a fourth carrier CA4 supporting the fourth planetary gear P4 such that the fourth planetary gear P4 is rotatable about its axis and about the axis of the fourth sun gear S4; and a fourth ring gear R4 meshing with the fourth sun gear S4 through the fourth planetary gear P4. For example, the fourth planetary gear set 30 has a gear ratio ρ4 of about 0.421. Where the numbers of teeth of the second sun gear S2, second ring gear R2, third sun gear S3, third ring gear R3, fourth sun gear S4 and fourth ring gear R4 are represented by ZS2, ZR2, ZS3, ZR3, ZS4 and ZR4, respectively, the above-indicated gear ratios ρ2, ρ3 and ρ4 are represented by ZS2/ZR2. ZS3/ZR3, and ZS4/ZR4, respectively. It will be understood that the automatic transmission portion 20 functions as a step-variable transmission portion.

In the automatic transmission portion 20, the second sun gear S2 and the third sun gear S3 are integrally fixed to each other as a unit, selectively connected to the power transmitting member 18 through a second clutch C2, and selectively fixed to the casing 12 through a first brake B1. The second carrier CA2 is selectively fixed to the casing 12 through a second brake B2, and the fourth ring gear R4 is selectively fixed to the casing 12 through a third brake B3. The second ring gear R2, third carrier CA3 and fourth carrier CA4 are integrally fixed to each other and fixed to the output shaft 22. The third ring gear R3 and the fourth sun gear S4 are integrally fixed to each other and selectively connected to the power transmitting member 18 through a first clutch C1.

Thus, the automatic transmission portion 20 and the differential portion 11 (power transmitting member 18) are selectively connected to each other through one of the first and second clutches C1, C2, which are provided to shift the automatic transmission portion 20. In other words, the first and second clutches C1, C2 function as coupling devices operable to switch a power transmitting path between the power distributing member 18 and the automatic transmission portion 18, to a selected one of a power transmitting state in which a vehicle drive force can be transmitted through the power transmitting path, and a power cut-off state (non-power-transmitting state) in which the vehicle drive force cannot be transmitted through the power transmitting path. When at least one of the first and second clutches C1 and C2 is placed in the engaged state, the power transmitting path is placed in the power transmitting state. When both of the first and second clutches C1, C2 are placed in the released state, the power transmitting path is placed in the power cut-off state. It will be understood that the first and second clutches C1, C2 function as a switching portion operable to switch the power transmitting path between the power transmitting state and the power cut-off state.

The automatic transmission portion 20 is operable to perform a so-called “clutch-to-clutch” shifting action to establish a selected one of its operating positions (gear positions) by an engaging action of one of coupling devices and a releasing action of another coupling device. The above-indicated operating positions have respective speed ratios γ (rotating speed N₁₈ of the power transmitting member 18/rotating speed N_{OUT} of the output shaft 22) which change as geometric series. As indicated in the table of FIG. 2, the first gear position having the highest speed ratio γ1 of about 3.357, for example, is established by engaging actions of the first clutch C1 and third brake B3, and the second gear position having the speed ratio γ2 of about 2.180, for example, which is lower than the speed ratio γ1, is established by engaging actions of the first clutch C1 and second brake B2. Further, the third gear position having the speed ratio γ3 of about 1.424, for example, which is lower than the speed ratio γ2, is established by engaging actions of the first clutch C1 and first brake B1, and the fourth gear position having the speed ratio γ4 of about 1.000, for example, which is lower than the speed ratio γ3, is established by engaging actions of the first clutch C1 and second clutch C2. The reverse gear position having the speed ratio γR of about 3.209, for example, which is intermediate between the speed ratios γ1 and γ2, is established by engaging actions of the second clutch C2 and the third brake B3, and the neutral position N is established when all of the first clutch C1, second clutch C2, first brake B1, second brake B2 and third brake B3 are placed in the released state.

The above-described first clutch C1, second clutch C2, first brake B1, second brake B2 and third brake B3 (hereinafter collectively referred to as clutches C and brakes B, unless otherwise specified) are hydraulically operated frictional coupling devices used in a conventional vehicular automatic transmission. Each of these frictional coupling devices is constituted by a wet-type multiple-disc clutch including a plurality of friction plates which are forced against each other by a hydraulic actuator, or a band brake including a rotary drum and one band or two bands which is/are wound on the outer circumferential surface of the rotary drum and tightened at one end by a hydraulic actuator. Each of the clutches C1, C2 and brakes B1-B3 is selectively engaged for connecting two members between which each clutch or brake is interposed.

In the transmission mechanism 10 constructed as described above, the differential portion 11 functioning as the continuously-variable transmission and the automatic transmission portion 20 cooperate with each other to constitute a continuously-variable transmission the speed ratio of which is continuously variable. While the differential portion 11 is controlled to hold its speed ratio constant, the differential portion 11 and the automatic transmission portion 20 cooperate to constitute a step-variable transmission the speed ratio of which is variable in steps.

When the differential portion 11 functions as the continuously-variable transmission while the automatic transmission portion 20 connected in series to the differential portion 11 functions as the step-variable transmission, the speed of the rotary motion transmitted to the automatic transmission portion 20 placed in a selected one of the gear positions M (hereinafter referred to as “input speed of the automatic transmission portion 20”), namely, the rotating speed of the power transmitting member 18 (hereinafter referred to as “transmitting-member speed N₁₈”) is continuously changed, so that the speed ratio of the hybrid vehicle drive system when the automatic transmission portion 20 is placed in the selected gear position M is continuously variable over a predetermined range. Accordingly, an overall speed ratio γT of the transmission mechanism 10 (rotating speed N_{IN} of the input shaft 14/rotating speed N_{OUT} of the output shaft 22) is continuously variable. Thus, the transmission mechanism 10 as a whole is operable as a continuously-variable transmission. The overall speed ratio γT is determined by the speed ratio γ0 of the differential portion 11 and the speed ratio γ of the automatic transmission portion 20.

For example, the transmitting-member speed N₁₈ is continuously variable over the predetermined range when the differential portion 11 functions as the continuously-variable transmission while the automatic transmission portion 20 is placed in a selected one of the first through fourth gear positions and reverse gear position as indicated in the table of FIG. 2. Accordingly, the overall speed ratio γT of the transmission mechanism 10 is continuously variable across the adjacent gear positions.

When the speed ratio γ0 of the differential portion 11 is held constant while the clutches C and brakes B are selectively engaged to establish the selected one of the first through fourth gear positions and the reverse gear position, the overall speed ratio γT of the transmission mechanism 10 is variable in step as geometric series. Thus, the transmission mechanism 10 is operable like a step-variable transmission.

When the speed ratio γ0 of the differential portion 11 is held constant at 1, for example, the overall speed ratio γT of the transmission mechanism 10 changes as the automatic transmission portion 20 is shifted from one of the first through fourth gear positions and reverse gear position to another, as indicated in the table of FIG. 2. When the speed ratio γ0 of the differential portion 11 is held constant at a value smaller than 1, for example, at about 0.7, while the automatic transmission portion 20 is placed in the fourth gear position, the overall speed ratio γT of the transmission mechanism 10 is controlled to be about 0.7.

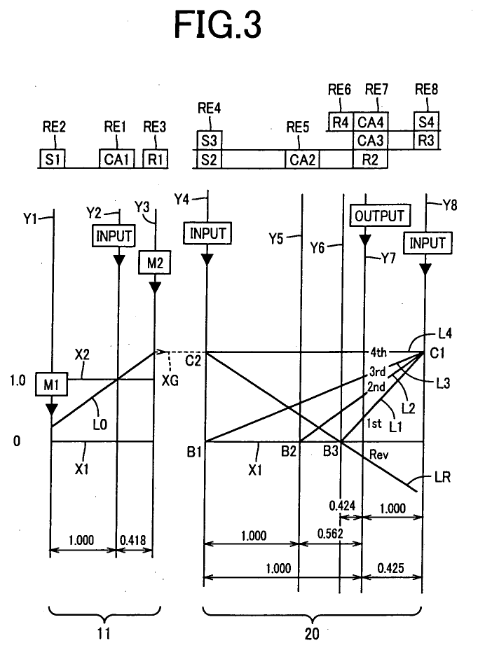

The collinear chart of FIG. 3 indicates, by straight lines, a relationship among the rotating speeds of the rotary elements in each of the gear positions of the transmission mechanism 10, which is constituted by the differential portion 11 and the automatic transmission portion 20. The different gear positions correspond to respective different states of connection of the rotary elements. The collinear chart of FIG. 3 is a rectangular two-dimensional coordinate system in which the gear ratios p of the planetary gear sets 24, 26, 28, 30 are taken along the horizontal axis, while the relative rotating speeds of the rotary elements are taken along the vertical axis. The horizontal line X1 indicates the rotating speed of 0, while the horizontal line X2 indicates the rotating speed of 1.0, that is, an operating speed N_{E} of the engine 8 connected to the input shaft 14. The horizontal line XG indicates the rotating speed of the power transmitting member 18.

Three vertical lines Y1, Y2 and Y3 corresponding to the power distributing mechanism 16 of the differential portion 11 respectively represent the relative rotating speeds of a second rotary element (second element) RE2 in the form of the first sun gear S1, a first rotary element (first element) RE1 in the form of the first carrier CA1, and a third rotary element (third element) RE3 in the form of the first ring gear R1. The distances between the adjacent ones of the vertical lines Y1, Y2 and Y3 are determined by the gear ratio ρ1 of the first planetary gear set 24. That is, the distance between the vertical lines Y1 and Y2 corresponds to “1” while the distance between the vertical lines Y2 and Y3 corresponds to the gear ratio ρ1. Further, five vertical lines Y4, Y5, Y6, Y7 and Y8 corresponding to the transmission portion 20 respectively represent the relative rotating speeds of a fourth rotary element (fourth element) RE4 in the form of the second and third sun gears S2, S3 integrally fixed to each other, a fifth rotary element (fifth element) RE5 in the form of the second carrier CA2, a sixth rotary element (sixth element) RE6 in the form of the fourth ring gear R4, a seventh rotary element (seventh element) RE7 in the form of the second ring gear R2 and third and fourth carriers CA3, CA4 that are integrally fixed to each other, and an eighth rotary element (eighth element) RE8 in the form of the third ring gear R3 and fourth sun gear S4 integrally fixed to each other. The distances between the adjacent ones of the vertical lines are determined by the gear ratios ρ2, ρ3 and ρ4 of the second, third and fourth planetary gear sets 26, 28, 30. In the relationship among the vertical lines of the collinear chart, the distances between the sun gear and carrier of each planetary gear set corresponds to “1” while the distances between the carrier and ring gear of each planetary gear set corresponds to the gear ratio ρ. In the differential portion 11, the distance between the vertical lines Y1 and Y2 corresponds to “1”, while the distance between the vertical lines Y2 and Y3 corresponds to the gear ratio ρ. In the automatic transmission portion 20, the distance between the sun gear and carrier of each of the second, third and fourth planetary gear sets 26, 28, 30 corresponds to “1” while the distance between the carrier and ring gear of each planetary gear set 26, 28, 30 corresponds to the gear ratio p.

Referring to the collinear chart of FIG. 3, the power distributing mechanism 16 (differential portion 11) of the transmission mechanism 10 is arranged such that the first rotary element RE1 (first carrier CA1) of the first planetary gear set 24 is integrally fixed to the input shaft 14 (engine 8), and the second rotary element RE2 is fixed to the first electric motor M1, while the third rotary element RE3 (first ring gear R1) is fixed to the power transmitting member 18 and the second electric motor M2, so that a rotary motion of the input shaft 14 is transmitted (input) to the automatic transmission portion 20 through the power transmitting member 18. A relationship between the rotating speeds of the first sun gear S1 and the first ring gear R1 is represented by an inclined straight line L0 which passes a point of intersection between the lines Y2 and X2.

In the differential state of the differential portion 11 in which the first through third rotary elements RE1-RE3 are rotatable relative to each other, for example, the rotating speed of the first sun gear S1, that is, the rotating speed of the first electric motor M1, which is represented by a point of intersection between the straight line L0 and the vertical line Y1, is raised or lowered by controlling the engine speed N_{E} , so that the rotating speed of the first carrier CA1 represented by a point of intersection between the straight line L0 and the vertical line Y2, if the rotating speed of the first ring gear R1 represented by a point of intersection between the straight line L0 and the vertical line Y3 is substantially held constant.

When the rotating speed of the first electric motor M1 is controlled such that the speed ratio γ0 of the differential portion 11 is held at 1, so that the rotating speed of the first sun gear S1 is made equal to the engine speed N_{E} , the straight line L0 is aligned with the horizontal line X2, so that the first ring gear R1, that is, the power transmitting member 18 is rotated at the engine speed N_{E} . When the rotating speed of the first electric motor M1 is controlled such that the speed ratio γ0 of the differential portion 11 is held at a value lower than 1, for example at 0.7, on the other hand, so that the rotating speed of the first sun gear S1 is zeroed, the power transmitting member 18 is rotated at a speed N₁₈ higher than the engine speed N_{E}.

In the automatic transmission portion 20, the fourth rotary element RE4 is selectively connected to the power transmitting member 18 through the second clutch C2, and selectively fixed to the casing 12 through the first brake B1, and the fifth rotary element RE5 is selectively fixed to the casing 12 through the second brake B2, while the sixth rotary element RE6 is selectively fixed to the casing 12 through the third brake B3. The seventh rotary element RE7 is fixed to the output shaft 22, while the eighth rotary element RE8 is selectively connected to the power transmitting member 18 through the first clutch C1.

The automatic transmission portion 20 is placed in the first gear position when the first clutch C1 and the third brake B3 are engaged in the state of the differential portion 11 in which a rotary motion of the differential portion 11 at a speed equal to the engine speed NE is input to the eighth rotary element RE8 of the automatic transmission portion 20. The rotating speed of the output shaft 22 in the first gear position is represented by a point of intersection between the vertical line Y7 indicative of the rotating speed of the seventh rotary element RE7 fixed to the output shaft 22 and an inclined straight line L1 which passes a point of intersection between the vertical line Y8 indicative of the rotating speed of the eighth rotary element RE8 and the horizontal line X2, and a point of intersection between the vertical line Y6 indicative of the rotating speed of the sixth rotary element RE6 and the horizontal line X1, as indicated in FIG. 3. Similarly, the rotating speed of the output shaft 22 in the second gear position established by the engaging actions of the first clutch C1 and second brake B2 is represented by a point of intersection between an inclined straight line L2 determined by those engaging actions and the vertical line Y7 indicative of the rotating speed of the seventh rotary element RE7 fixed to the output shaft 22. The rotating speed of the output shaft 22 in the third gear position established by the engaging actions of the first clutch C1 and first brake B1 is represented by a point of intersection between an inclined straight line L3 determined by those engaging actions and the vertical line Y7 indicative of the rotating speed of the seventh rotary element RE7 fixed to the output shaft 22. The rotating speed of the output shaft 22 in the fourth gear position established by the engaging actions of the first clutch C1 and second clutch C2 is represented by a point of intersection between a horizontal line L4 determined by those engaging actions and the vertical line Y7 indicative of the rotating speed of the seventh rotary element RE7 fixed to the output shaft 22.

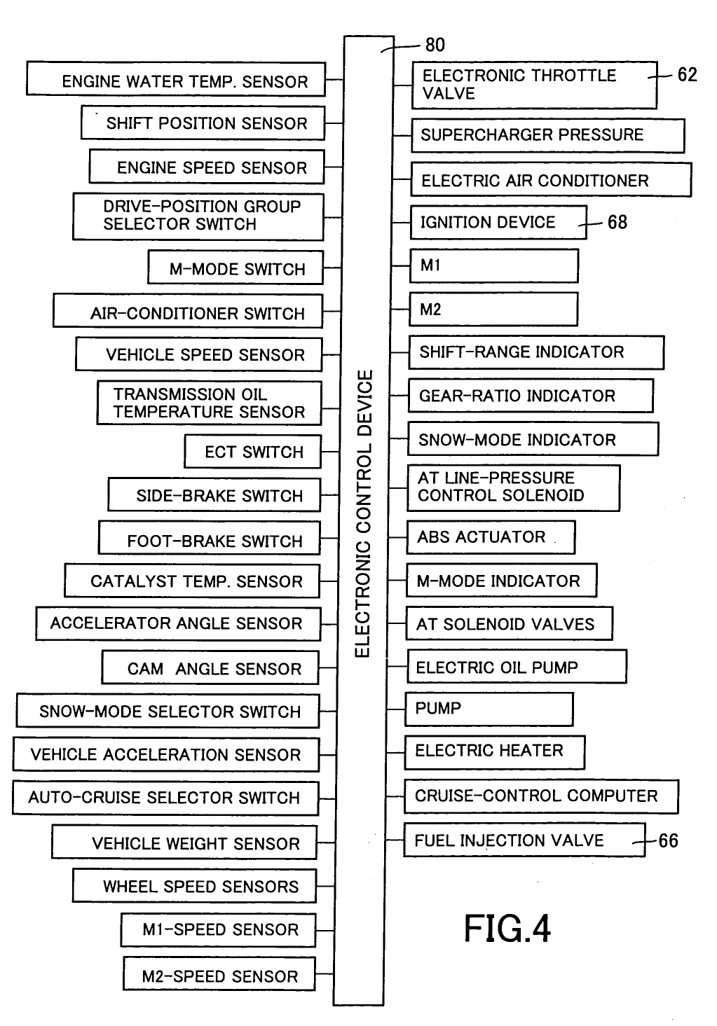

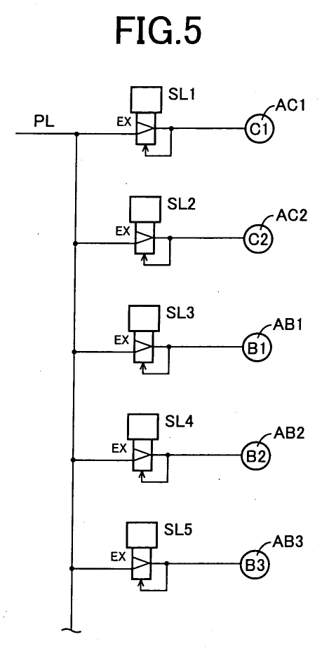

FIG. 4 illustrates signals received by an electronic control device 80 provided to control the transmission mechanism 10, and signals generated by the electronic control device 80. This electronic control device 80 includes a so-called microcomputer incorporating a CPU, a ROM, a RAM and an input/output interface, and is arranged to process the signals according to programs stored in the ROM while utilizing a temporary data storage function of the ROM, to implement hybrid drive controls of the engine 8 and first and second electric motors M1 and M2, and drive controls such as shifting controls of the automatic transmission portion 20.

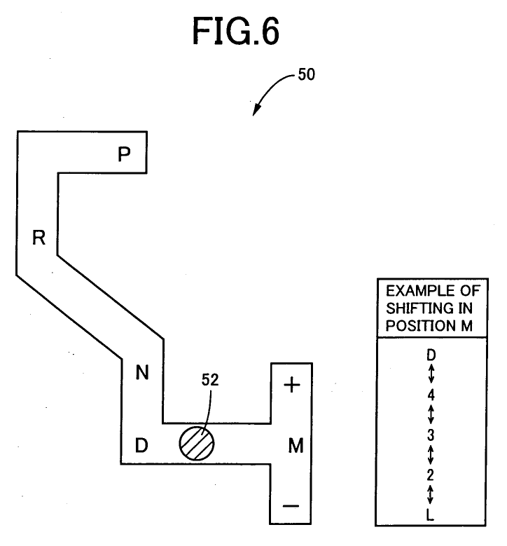

The electronic control device 80 is arranged to receive from various sensors and switches shown in FIG. 4, various signals such as: a signal indicative of a temperature TEMP_{W} of cooling water of the engine 8; a signal indicative of a selected one of operating positions P_{SH} of a shift lever 52 (shown in FIG. 6); a signal indicative of the number of operations of the shift lever 52 from a manual forward-drive shifting position M (described below); a signal indicative of the operating speed N_{E} of the engine 8; a signal indicative of a value indicating a selected group of forward-drive positions of the transmission mechanism 10; a signal indicative of an M mode (manual shifting mode); a signal indicative of an operated state of an air conditioner; a signal indicative of a vehicle speed V corresponding to the rotating speed N_{OUT} of the output shaft 22 (hereinafter referred to as “output shaft speed”); a signal indicative of a temperature T_{OIL} of a working fluid or oil of the automatic transmission portion 20 (hereinafter referred to as “working fluid temperature TH_{ATF}”); a signal indicative of an operated state of a side brake; an output signal of a brake switch 76 (shown in FIG. 7) indicative of an operated state of a brake operating member in the form of a foot brake pedal 78 (shown FIG. 7); a signal indicative of a temperature of a catalyst; a signal indicative of a required amount of an output of the vehicle in the form of an amount of operation (an angle of operation) A_{CC} of a manually operable vehicle accelerating member in the form of an accelerator pedal 74 (shown in FIG. 7), which is detected by an accelerator sensor 72; a signal indicative of an angle of a cam; a signal indicative of the selection of a snow drive mode; a signal indicative of a longitudinal acceleration value G of the vehicle; a signal indicative of the selection of an auto-cruising drive mode; a signal indicative of a weight of the vehicle; signals indicative of speeds of the wheels of the vehicle; a signal indicative of a rotating speed N_{M1} of the first electric motor M1 (hereinafter referred to as “first electric motor speed N_{M1}); a signal indicative of a rotating speed N_{M2} of the second electric motor M2 (hereinafter referred to as “second electric motor speed N_{M2}); and a signal indicative of an amount of electric energy SOC stored in an electric-energy storage device 60 (shown in FIG. 7).

The electronic control device 80 is further arranged to generate various signals such as: control signals to be applied to an engine output control device 58 (shown in FIG. 7) to control the output of the engine 8, such as a drive signal to drive a throttle actuator 64 for controlling an angle of opening θ_{TH} of an electronic throttle valve 62 disposed in an intake pipe 60 of the engine 8, a signal to control an amount of injection of a fuel by a fuel injecting device 66 into the intake pipe 60 or cylinders of the engine 8, a signal to be applied to an ignition device 68 to control the ignition timing of the engine 8, and a signal to adjust a supercharger pressure of the engine 8; a signal to operate the electric air conditioner; signals to operate the first and second electric motors M1 and M2; a signal to operate a shift-range indicator for indicating the selected operating or shift position of the shift lever 52; a signal to operate a gear-ratio indicator for indicating the gear ratio; a signal to operate a snow-mode indicator for indicating the selection of the snow drive mode; a signal to operate an ABS actuator for anti-lock braking of the wheels; a signal to operate an M-mode indicator for indicating the selection of the M-mode; signals to operate solenoid-operated valves in the form of linear solenoid valves incorporated in a hydraulic control unit 70 (shown in FIG. 7) provided to control the hydraulic actuators of the hydraulically operated frictional coupling devices of the differential portion 11 and automatic transmission portion 20; a signal to operate a regulator valve incorporated in the hydraulic control unit 70, to regulate a line pressure PL; a signal to control an electrically operated oil pump which is hydraulic pressure source for generating a hydraulic pressure that is regulated to the line pressure PL; and a signal to drive an electric heater; a signal to be applied to a cruise-control computer.

FIG. 5 shows a hydraulic circuit of the hydraulic control unit 70 arranged to control linear solenoid valves SL1-SL5 for controlling hydraulic actuators (hydraulic cylinders) AC1, AC2, AB1, AB2 and AB3 for actuating the clutches C1, C2 and brakes B1-B3.

As shown in FIG. 5, the hydraulic actuators AC1, AC2, AB1, AB2, AB3 are connected to the respective linear solenoid valves SL1-SL5, which are controlled according to control commands from the electronic control device 80, for adjusting the line pressure PL into respective engaging pressures PC1, PC2, PB1, PB2 and PB3 to be applied directly to the respective hydraulic actuators AC1, AC2, AB1, AB2, AB3. The line pressure PL is a pressure which is generated by the mechanical oil pump 40 driven by the engine 8 or the electric oil pump 76 provided in addition to the mechanical oil pump 40, and which is regulated by a relief-type pressure regulator valve according to a load of the engine 8 as represented by the operation amount A_{CC} of the accelerator pedal or the opening angle θ_{TH} of the electronic throttle valve 62, for example.

The linear solenoid valves SL1-SL5 have substantially the same construction, and are controlled independently of each other by the electronic control device 80, to adjust the hydraulic pressures of the hydraulic actuators AC1, AC2, AB1, AB2, AB3 independently of each other, for controlling the engaging pressures PC1, PC2, PB1, PB2, PB3, so that the appropriate two coupling devices (C1, C2, B1, B2, B3) are engaged to shift the automatic transmission portion 20 to the selected operating position or gear position. A shifting action of the automatic transmission portion 20 from one position to another is a so-called “clutch-to-clutch” shifting action involving an engaging action of the coupling devices (C, B) and a releasing action another of the coupling devices, which take place concurrently.

FIG. 6 shows an example of a manually operable shifting device in the form of a shifting device 50. The shifting device 50 includes the above-described shift lever 52, which is disposed laterally adjacent to an operator's seat of the vehicle, for example, and which is manually operated to select one of the plurality of operating positions P_{SH}.

The operating positions P_{SH} of the shift lever 52 consists of: a parking position P for placing the transmission mechanism 10 (namely, automatic transmission portion 20) in a neutral state in which a power transmitting path through the automatic transmission portion 20 is disconnected while at the same time the output shaft 22 is placed in the locked state; a reverse-drive position R for driving the vehicle in the rearward direction; a neutral position N for placing the transmission mechanism 10 in the neutral state; an automatic forward-drive shifting position D for establishing an automatic shifting mode; and the above-indicated manual forward-drive shifting position M for establishing a manual shifting mode. In the automatic shifting mode, the overall speed ratio γT is determined by the continuously variable speed ratio of the differential portion 11 and the speed ratio of the automatic transmission portion 20 which changes in steps as a result of an automatic shifting action of the automatic transmission portion 20 from one of the first through fourth gear positions to another. In the manual shifting mode, the number of the gear positions available is limited by disabling the automatic transmission portion 20 to be shifted to the relatively high gear position or positions.

As the shift lever 52 is operated to a selected one of the operating positions P_{SH}, the hydraulic control unit 70 is electrically operated to switch the hydraulic circuit to establish the rear-drive position R, neutral position N, and one of the forward-drive first through fourth gear positions, as indicated in the table of FIG. 2.

The above-indicated parking position P and the neutral position N are non-drive positions selected when the vehicle is not driven, while the above-indicated reverse-drive position R, and the automatic and manual forward-drive positions D, M are drive positions selected when the vehicle is driven. In the non-drive positions P, N, the power transmitting path in the automatic transmission portion 20 is in the power-cut-off state established by releasing both of the clutches C1 and C2, as shown in the table of FIG. 2. In the drive positions R, D, M, the power transmitting path in the automatic transmission portion 20 is in the power-transmitting state established by engaging at least one of the clutches C1 and C2, as also shown in the table of FIG. 2.

Described in detail, a manual operation of the shift lever 52 from the parking position P or neutral position N to the reverse-drive position R causes the second clutch C2 to be engaged for switching the power transmitting path in the automatic transmission portion 20 from the power-cut-off state to the power-transmitting state. A manual operation of the shift lever 52 from the neutral position N to the automatic forward-drive position D causes at least the first clutch C1 to be engaged for switching the power transmitting path in the automatic transmission portion 20 from the power-cut-off state to the power-transmitting state. A manual operation of the shift lever 52 from the rear-drive position R to the parking position P or neutral position N cause the second clutch C2 to be released for switching the power transmitting path in the automatic transmission portion 20 from the power-transmitting state to the power-cut-off state. A manual operation of the shift lever 52 from the automatic forward-drive position D to the neutral position N causes the first clutch C1 and the second clutch C2 to be released for switching the power transmitting path from the power-transmitting state to the power-cut-off state.

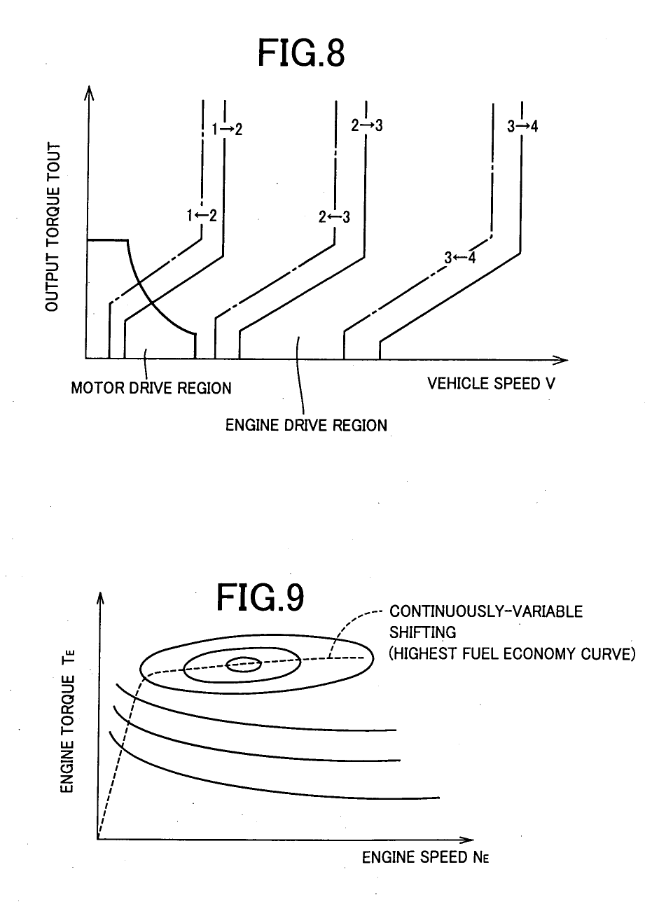

Referring to the functional block diagram of FIG. 7, the electronic control device 80 includes a step-variable shifting control portion 82, a hybrid control portion 84, a toque-variation reducing portion 101, a clutch pressure determining portion 104, a vehicle speed determining portion 106, an accelerator-operation-amount determining portion 108, and a brake operation determining portion 112. The step-variable shifting control portion 82 is configured to determine whether a shifting action of the automatic transmission portion 20 should take place, that is, to determine the gear position to which the automatic transmission portion 20 should be shifted. This determination is made on the basis of a condition of the vehicle represented by the actual vehicle running speed V and the actual output torque Tour of the automatic transmission portion 20, and according to a stored shifting boundary line map (shifting control map or relation) which represents shift-up boundary lines indicated by solid lines in FIG. 8 and shift-down boundary lines indicated by one-dot chain lines in FIG. 8.

The step-variable shifting control portion 82 generates a shifting command (hydraulic control command) to be applied to the hydraulic control unit 70, to engage and release the appropriate two hydraulically operated frictional coupling devices (C1, C2, B1, B2, B3), for establishing the determined gear position of the automatic transmission portion 20 according to the table of FIG. 2. Described in detail, the step-variable shifting control portion 82 commands the hydraulic control unit 70 to control the appropriate two linear solenoid valves SL incorporated in the hydraulic control unit 70, for activating the appropriate hydraulic actuators of the appropriate two frictional coupling devices (C, B) to concurrently engage one of the two frictional coupling devices and release the other frictional coupling device, to effect the clutch-to-clutch shifting action of the automatic transmission portion 20 to the determined gear position.

The hybrid control portion 84 controls the engine 8 to be operated with high efficiency, and controls the first and second electric motors M1, M2 so as to optimize a proportion of drive forces generated by the engine 8 and the second electric motor M2, and a reaction force generated by the first electric motor M1 during its operation as the electric generator, for thereby controlling the speed ratio γ0 of the differential portion 11 operating as the electric continuously-variable transmission. For instance, the hybrid control portion 84 calculates a target (required) vehicle output at the present running speed V of the vehicle, on the basis of the operation amount A_{CC} of the accelerator pedal 74 used as an operator's required vehicle output and the vehicle running speed V, and calculate a target total vehicle output on the basis of the calculated target vehicle output and a required amount of generation of an electric energy by the first electric motor M1. The hybrid control portion 84 calculates a target output of the engine 8 to obtain the calculated target total vehicle output, while taking account of a power transmission loss, a load acting on various devices of the vehicle, an assisting torque generated by the second electric motor M2, etc. The hybrid control portion 84 controls the speed N_{E} and torque T_{E} of the engine 8, so as to obtain the calculated target engine output, and the amount of generation of the electric energy by the first electric motor M1.

The hybrid control portion 84 is arranged to implement the hybrid control while taking account of the presently selected gear position of the automatic transmission portion 20, so as to improve the drivability of the vehicle and the fuel economy of the engine 8. In the hybrid control, the differential portion 11 is controlled to function as the electric continuously-variable transmission, for optimum coordination of the engine speed N_{E} for its efficient operation, and the rotating speed of the power transmitting member 18 determined by the vehicle speed V and the selected gear position of the transmission portion 20. That is, the hybrid control portion 82 determines a target value of the overall speed ratio γT of the transmission mechanism 10, so that the engine 8 is operated according to a stored highest-fuel-economy curve (fuel-economy map or relation) indicated by broken line in FIG. 9. The target value of the overall speed ratio γT of the transmission mechanism 10 permits the engine torque T_{E} and speed N_{E} to be controlled so that the engine 8 provides an output necessary for obtaining the target vehicle output (target total vehicle output or required vehicle drive force). The highest-fuel-economy curve is obtained by experimentation so as to satisfy both of the desired operating efficiency and the highest fuel economy of the engine 8, and is defined in a two-dimensional coordinate system defined by an axis of the engine speed N_{E} and an axis of the engine torque T_{E}. The hybrid control portion 82 controls the speed ratio γ0 of the differential portion 11, so as to obtain the target value of the overall speed ratio γT, so that the overall speed ratio γT can be controlled within a predetermined range.

In the hybrid control, the hybrid control portion 84 controls an inverter 54 such that the electric energy generated by the first electric motor M1 is supplied to an electric-energy storage device 56 and the second electric motor M2 through the inverter 54. That is, a major portion of the drive force produced by the engine 8 is mechanically transmitted to the power transmitting member 18, while the remaining portion of the drive force is consumed by the first electric motor M1 to convert this portion into the electric energy, which is supplied through the inverter 54 to the second electric motor M2, so that the second electric motor M2 is operated with the supplied electric energy, to produce a mechanical energy to be transmitted to the power transmitting member 18. Thus, the drive system is provided with an electric path through which an electric energy generated by conversion of a portion of a drive force of the engine 8 is converted into a mechanical energy.

The hybrid control portion 84 is further arranged to hold the engine speed N_{E} substantially constant or at a desired value, by controlling the first electric motor speed N_{M1} and/or the second electric motor speed N_{M2} owing to the electric CVT function of the differential portion 11, irrespective of whether the vehicle is stationary or running. In other words, the hybrid control portion 84 is capable of controlling the first electric motor speed N_{M1} as desired while holding the engine speed N_{E} substantially constant or at a desired value. For example, the hybrid control portion 84 raises the engine speed N_{E} by raising the first electric motor speed N_{M1} during running of the vehicle while the second electric motor speed N_{M2} determined by the vehicle running speed V (rotating speed of the drive wheels 34) is held substantially constant.

To raise the engine speed N_{E} during running of the vehicle, for example, the hybrid control portion 84 raises the first electric motor speed N_{M1} while the second electric motor speed N_{M2} determined by the vehicle speed V (rotating speed of the drive wheels 34) is held substantially constant, as is apparent from the collinear chart of FIG. 3. To hold the engine speed N_{E} substantially constant during a shifting action of the automatic transmission portion 20, the hybrid control portion 84 changes the first electric motor speed N_{M1} in a direction opposite to a direction of change of the second electric motor speed N_{M2} due to the shifting action of the automatic transmission portion 20.

The hybrid control portion 84 includes engine output control means functioning to command the engine-output control device 58 for controlling the engine 8, so as to provide a required output, by controlling the throttle actuator 64 to open and close the electronic throttle valve 62, and controlling an amount and time of fuel injection by the fuel injecting device 66 into the engine 8, and/or the timing of ignition of the igniter by the ignition device 68, alone or in combination.

For instance, the hybrid control portion 84 is basically arranged to control the throttle actuator 64 on the basis of the operation amount A_{CC} of the accelerator pedal and according to a predetermined stored relationship (not shown) between the operation amount A_{CC} and the opening angle θ_{TH} of the electronic throttle valve 62 such that the opening angle θ_{TH} increases with an increase of the operation amount A_{CC} . The engine output control device 58 controls the throttle actuator 64 to open and close the electronic throttle valve 62, controls the fuel injecting device 66 to control the fuel injection, and controls the ignition device 68 to control the ignition timing of the igniter, for thereby controlling the torque of the engine 8, according to the commands received from the hybrid control portion 84.

The hybrid control portion 84 is capable of establishing a motor-drive mode to drive the vehicle by the electric motor, by utilizing the electric CVT function (differential function) of the differential portion 11, irrespective of whether the engine 8 is in the non-operated state or in the idling state. For example, the hybrid control portion 84 establishes the motor-drive mode, when the operating efficiency of the engine 8 is relatively low, or when the vehicle speed V is comparatively low or when the vehicle is running in a low-load state. For reducing a dragging of the engine 8 in its non-operated state and improving the fuel economy in the motor-drive mode, the hybrid control portion 84 is configured to hold the engine speed N_{E} at zero or substantially zero as needed, owing to the electric CVT function (differential function) of the differential portion 11, that is, by controlling the differential portion 11 to perform its electric CVT function, so that the first electric motor speed N_{M1} is controlled to be in a non-load state, so as to be freely rotated to have a negative speed N_{M1}.

The hybrid control portion 84 is further capable of performing a so-called “drive-force assisting” operation (torque assisting operation) to assist the engine 8, even in the engine-drive region of the vehicle condition, by supplying an electric energy from the first electric motor M1 or the electric-energy storage device 60 to the second electric motor M2 through the above-described electric path, so that the second electric motor M2 is operated to transmit a drive torque to the drive wheels 34.

The hybrid control portion 84 is further configured to place the first electric motor M1 in a non-load state in which the first electric motor M1 is freely rotated, so that the differential portion 11 is placed in a state similar to the power cut-off state in which power cannot be transmitted through the power transmitting path within the differential portion 11, and no output can be generated from the differential portion 11. Namely, the hybrid control portion 84 is arranged to place the first electric motor M1 in the non-load state, for thereby placing the differential portion 11 in a neutral state in which the power transmitting path is electrically cut off.

The hybrid control portion 84 functions as regeneration control means for operating the second electric motor M2 as the electric generator with a kinetic energy of the running vehicle, that is, with a drive force transmitted from the drive wheels 34 toward the engine 8, during coasting of the vehicle with the accelerator pedal 74 placed in the non-operated position, or during brake application to the vehicle with hydraulically operated wheel brakes 86 for the drive wheels 34, which are shown in FIG. 7. An electric energy generated by the second electric motor M2 is stored in the electric-energy storage device 56 through the inverter 54, for improving the fuel economy of the vehicle. The amount of electric energy to be generated by the second electric motor M2 is determined on the basis of the electric energy amount SOC stored in the electric-energy storage device 56, and a desired proportion of a regenerative braking force produced by the second electric motor M2 operated as the electric generator, with respect to a total braking force which corresponds to the operating amount of a brake pedal and which consists of the regenerative braking force and a hydraulic braking force produced by the hydraulically operated wheel brakes 86.

When the engine 8 is started upon switching of the power transmitting path (between the differential portion 11 and the drive wheels 34) from the power cut-off state to the power transmitting state as a result of an operation of the shift lever 52 of the shifting device 50 from the neutral position N to the automatic forward-drive shifting position D, reverse drive position R or manual forward-drive shifting position M (hereinafter referred to as an “N-to-D shifting operation”), the torque of the power transmitting member 18 functioning as the output shaft of the differential portion 11 and the input shaft of the automatic transmission portion 20 tends to vary due to a variation of the engine torque T_{E}. Consequently, the rotating speed of the power transmitting member 18 and the operating speed of the second electric motor M2 connected to the power transmitting member 18 vary, giving rise to a risk of a large amount of engaging shock of hydraulically operated frictional coupling devices such as the first clutch C1 incorporated in the automatic transmission portion 20. Thus, the variation of the input torque of the automatic transmission portion 20 upon the N-to-D shifting operation tends to cause a large amount of engaging shock of the frictional coupling devices. To overcome this drawback, the control apparatus in the form of the electronic control device 80 includes the above-indicated torque-variation reducing portion 100 which comprises a first-power-source torque-variation reducing portion 100 and a third-power-source torque-variation reducing portion 102. The torque-variation reducing portion 100 is configured to reduce an amount of variation of the torque of the power transmitting member 18 that may cause the engaging shock of the frictional coupling devices, for thereby reducing an amount of variation of the speeds of the power transmitting member 18 and the second electric motor M2.

The torque-variation reducing portion 101 is operated on the basis of results of determinations by the above-indicated clutch pressure determining portion 104, vehicle speed determining portion 106, accelerator-operation-amount determining portion 108, and brake operation determining portion 112. These determination portions 104, 106, 108 and 112 will be described in detail.

The clutch pressure determining portion 104 is configured to detect the engaging pressure PC1 of the first clutch C1 to be engaged for establishing the first, second, third and fourth gear positions of the automatic transmission portion 20 (or the engaging pressure PC2 of the second clutch C2 to be engaged for establishing the reverse gear position R), and to determine whether the detected engaging pressure PC1 is higher than a predetermined first threshold value (at which an engaging action is initiated) and lower than a predetermined second threshold value (at which the first clutch C1 is sufficiently engaged). The engaging pressure PC1 may be detected by a pressure sensor provided for detecting a hydraulic pressure of the hydraulic actuator for the first clutch C1, or may be obtained on the basis of a hydraulic command to be applied from the electronic control device 80 to the linear solenoid valve SL1 provided to regulate the engaging pressure PC1. The predetermined first and second threshold values are obtained by experimentation. When the detected engaging pressure PC1 is held within a range between these first and second threshold values, an affirmative determination is obtained by the clutch pressure determining portion 104. The affirmative determination regarding the engaging pressure PC of the first clutch C1 indicates that the first clutch C1 is in the process of the engaging action, and is one of running states of the vehicle that should be satisfied to enable the torque-variation reducing portion 101 to be operated.

The vehicle speed determining portion 106 is configured to determine whether the vehicle speed V is lower than a predetermined threshold value which is obtained by experimentation. The vehicle speed V is calculated on the basis of the rotating speed N_{OUT} of the output shaft 22 of the automatic transmission portion 20 which is detected by a speed sensor (not shown). When the vehicle speed V is comparatively low, reduction of an engaging shock of the first clutch C1 upon the N-to-D shifting operation of the shift lever 52 is more important than rapidness of the engaging action (engaging response) of the first clutch C1. When the vehicle speed V is comparatively high, on the other hand, the rapidness of the engaging action of the first clutch C1 (frictional coupling device) upon the N-to-D shifting operation is more important than the reduction of the engaging shock of the first clutch C1. Therefore, the predetermined threshold value of the vehicle speed V is determined such that the vehicle operator wants to reduce the engaging shock of the first clutch C1 when the vehicle speed V is lower than the threshold value, and wants to have a high engaging response of the first clutch C1 when the vehicle speed V is higher than the threshold value. When the vehicle speed V is lower than the predetermined threshold value, an affirmative determination is obtained by the vehicle speed determining portion 106. The affirmative determination regarding the vehicle speed V is another running state of the vehicle that should be satisfied to enable the torque-variation reducing portion 101 to be operated.

The accelerator-operation-amount determining portion 108 is configured to determine whether the operation amount A_{CC} of the accelerator pedal 74 detected by the accelerator sensor 72 is smaller than a predetermined threshold value which is obtained by experimentation. When the operation amount A_{CC} of the accelerator pedal 74 is comparatively small, the reduction of the a vehicle accelerating shock upon depression of the accelerator pedal 74 is more important than accelerating performance or drivability of the vehicle by depression of the accelerator pedal 74. Therefore, the predetermined threshold value of the operation amount A_{CC} is determined such that the vehicle operator wants to reduce the vehicle accelerating shock when the operation amount A_{CC} is smaller than the threshold value, and wants to have a high vehicle accelerating performance when the operation amount A_{CC} is larger than the threshold value. When the operation amount A_{CC} is smaller than the predetermined threshold value, that is, when the reduction of the vehicle accelerating shock (reduction of the engaging shock of the first clutch C1) is more important, an affirmative determination is obtained by the accelerator-operation-amount determining portion 108. It is noted that since the operation amount A_{CC} is proportional to a drive force produced by the engine 8, the accelerator-operation-amount determining portion 108 is considered to determine whether the engine torque T_{E} is smaller than a predetermined threshold value. The affirmative determination regarding the operation amount A_{CC} of the accelerator pedal 74 or engine torque T_{E} is a vehicle running state which is established by an operation of the vehicle operator and which should be satisfied to enable the torque-variation reducing portion 101 to be operated, when a negative determination is obtained by the vehicle speed determining portion 106.

The brake operation determining portion 112 is configured to determine whether the foot brake pedal 78 (shown in FIG. 7) for operating wheel brakes of a service braking system is in the non-operated position. This determination is made on the basis of an output signal of the brake switch 76 (also shown in FIG. 7). Alternatively, the brake operation determining portion 112 is configured to determine whether a hydraulic pressure of a master cylinder of the service braking system is lower than a predetermined threshold value. When the foot brake pedal 78 is in an operated position or when the master cylinder pressure is higher than the threshold value, this indicates that the vehicle operator desires to stop the vehicle, rather than wants to reduce a vehicle stopping shock. The threshold value, which is obtained by experimentation, is a value at which brake application to the vehicle wheels by the wheel brakes is initiated. When the foot brake pedal 74 is in the non-operated position, that is, when the vehicle operator wants to reduce the vehicle stopping shock, an affirmative determination is obtained by the brake operation determining portion 112. The affirmative determination regarding the operation of the foot brake pedal 74 is a further vehicle running state which is established by the vehicle operator and which should be satisfied to enable the torque-variation reducing portion 101 to be operated, when the negative determination is obtained by the vehicle speed determining portion 106.

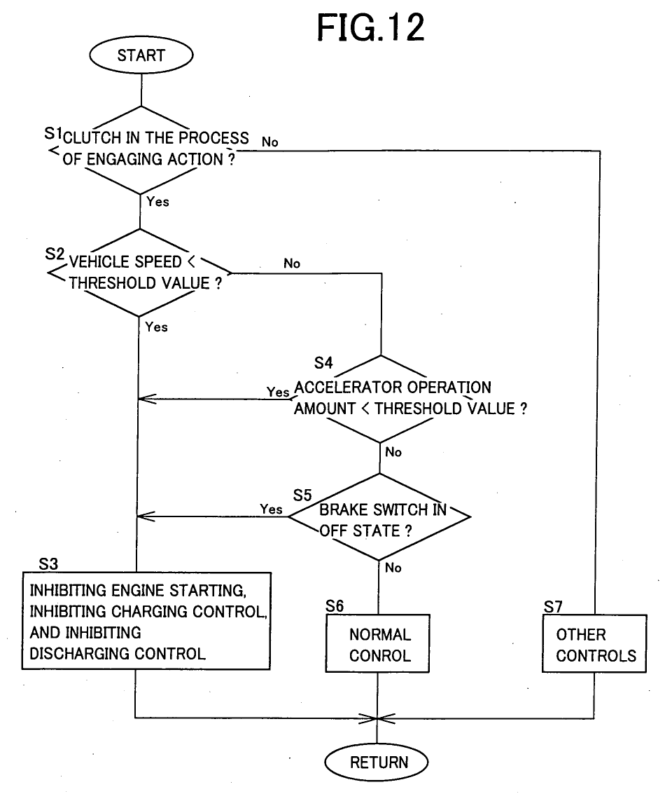

As is understood from a flow chart of FIG. 12, the torque-variation reducing portion 101 is enabled to be operated when the affirmative determination is obtained by one of the vehicle speed determining portion 106, accelerator-operation-amount determining portion 108 and brake operation determining portion 112 while the affirmative determination is obtained by the clutch pressure determining portion 104.

As described above, the torque-variation reducing portion 101 includes the first-power-source torque-variation reducing portion 100 and the third-power-source torque-variation reducing portion 102. When the torque-variation reducing portion 101 is enabled to be operated upon the N-to-D shifting operation, the first-power-source torque-variation reducing portion 100 implements a control to reduce an amount of variation of the torque T_{E} of the engine 8 from a target value, and the third-power-source torque-variation reducing portion 102 implements a control to reduce an amount of variation of the torque of the second electric motor M2 from a target value. These controls are implemented to reduce the torque variations depending upon the specific running states of the vehicle.

For example, the first-power-source torque-variation reducing portion 100 is configured to inhibit starting of the engine 8 upon the N-to-D shifting operation of the shift lever 52. If the engine 8 is started upon the N-to-D shifting operation, the engine torque varies, and the rotating speed N₁₈ of the power transmitting member 18 connected to the differential portion 11 and the operating speed N_{M2} of the second electric motor M2 will vary. Accordingly, when the first gear position of the automatic transmission portion 20 is established upon the N-to-D shifting operation, there is a risk of generation of an engaging shock of the first clutch C1 (and the third brake 3) due to a variation of the rotating speed N₁₈ of the power transmitting member 18 which functions as the input shaft of the automatic transmission portion 20. In view of this risk, the first-power-source torque-variation reducing portion 100 inhibits the starting control of the engine 8, to thereby prevent the torque variation of the engine 8, and prevent the engaging shock of the first clutch C1. In this case, the vehicle is driven by the second electric motor M2, while the third-power-source torque-variation reducing portion 102 permits a normal drive force control of the second electric motor M2. If the starting control of the engine 8 has been initiated prior to the N-to-D shifting operation, that is, before the operations of the first-power-source torque-variation and third-power-source torque-variation reducing portions 100, 102 are initiated, the first-power-source torque-variation reducing portion 100 permits continuation of the starting control of the engine 8 even after the operations of the portions 100, 102 are initiated. If the starting control of the engine 8 which has already been started is interrupted by the first-power-source torque-variation reducing portion 100, this interruption causes a torque variation of the engine 8. Therefore, the already initiated starting control of the engine 8 is continued. Where the starting control of the engine 8 is inhibited by the first-power-source torque-variation reducing portion 100, the target value of the engine torque T_{E} is zero. Where the normal drive force control of the second electric motor M2 is permitted by the third-power-source torque-variation reducing portion 102, the target value of the torque of the second electric motor M2 is a value to be obtained by the normal drive force control. It will be understood that the starting control of the engine 8 is one of controls which are implemented depending upon the running state of the vehicle and which cause a torque variation of the vehicle drive system.

The first-power-source torque-variation reducing portion 100 is further configured to inhibit a stopping control of the engine 8 upon the N-to-D shifting operation of the shift lever 52. The engine 8 is operated to charge the electric-energy storage device 56 even while the vehicle is stopped with the shift lever 52 placed in the neutral position N, if the amount of electric energy SOC stored in the electric-energy storage device 456 is smaller than a predetermined lower limit. When the electric energy amount SOC has increased to the lower limit, the operation of the engine 8 is stopped, so that the engine torque T_{E} transmitted to the differential portion 11 varies, giving rise to generation of an engine stopping shock. In view of this drawback, the first-power-source torque-variation reducing portion 100 inhibits stopping of the engine 8 in the above-described case, for preventing the torque variation. In this instance, the vehicle is driven by only the engine 8, or by both the engine 8 and the second electric motor M2. In the latter case, the third-power-source torque-variation reducing portion 102 permits the drive force control of the second electric motor M2. If the stopping control of the engine 8 has been initiated prior to the N-to-D shifting operation, that is, before the operations of the first-power-source torque-variation and third-power-source torque-variation reducing portions 100, 102 are initiated, the first-power-source torque-variation reducing portion 100 permits continuation of the stopping control of the engine 8 even after the operations of the portions 100, 102 are initiated. If the stopping control of the engine 8 which has already been started is interrupted by the first-power-source torque-variation reducing portion 100, this interruption causes a torque variation of the engine 8. Therefore, the already initiated stopping control of the engine 8 is continued. It will be understood that the stopping control of the engine 8 is another control which is implemented depending upon the running state of the vehicle and which causes a torque variation of the vehicle drive system.

The first-power-source and third-power-source torque-variation reducing portions 100, 102 are further configured to inhibit a charging control, that is, an operation of the engine 8 to charge the electric-energy storage device 56 upon the N-to-D shifting operation of the shift lever 52. In the charging control, the engine 8 is operated to operate the first electric motor M1 as an electric generator for generating an electric energy for charting the electric-energy storage device 56. The first-power-source and third-power-source torque-variation reducing portions 100, 102 inhibit starting or stopping of the charging control upon the N-to-D shifting operation, and the charging controls which involve a change of the drive force to be transmitted from the engine 8 to the first electric motor M1 to change the amount of electric energy generated by the first electric motor M1, and which cause torque variations of the engine 8 and the second electric motor M2. Namely, the first-power-source and third-power-source torque-variation reducing portions 100, 102 permit continuation of the charging control already initiated prior to the N-to-D shifting operation. Thus, the first-power-source and third-power-source torque-variation reducing portions 100, 102 reduce the variations of the torque and speeds of the power transmitting member 18 and second electric motor M2. In this case, the first-power-source torque-variation reducing portion 100 permits the drive force control of the engine 8, and the third-power-source torque-variation reducing portion 102 permits the drive force control of the second electric motor M2. It will be understood that the charging control of the electric-energy storage device 56 involving an operation of the engine 8 to drive the first electric motor M1 as an electric generator is another control which is implemented depending upon the running state of the vehicle and which causes a torque variation of the vehicle drive system.

The first-power-source and third-power-source torque-variation reducing portions 100, 102 are further configured to inhibit a discharging control of the electric-energy storage device 56 upon the N-to-D shifting operation of the shift lever 52. The discharging control of the electric-energy storage device 56 is implemented when the stored electric energy amount SOC exceeds a predetermined upper limit. For example, the discharging control is an operation of the second electric motor M2 with an electric energy supplied from the electric-energy storage device 56, to provide a part of the vehicle drive force, so that a suitable amount of electric energy stored in the electric-energy storage device 56 is consumed so that the electric energy amount SOC is reduced below the upper limit. The first-power-source and third-power-source torque-variation reducing portions 100, 102 inhibit starting or stopping of the discharging control upon the N-to-D shifting operation, and the discharging controls which involve a change of the drive force to be transmitted from the engine 8 to the second electric motor M2 to change the amount of electric energy discharged from the electric-energy storage device 56, and which cause torque variations of the engine 8 and the second electric motor M2. Namely, the first-power-source and third-power-source torque-variation reducing portions 100, 102 permit continuation of the discharging control already initiated prior to the N-to-D shifting operation. Thus, the first-power-source and third-power-source torque-variation reducing portions 100, 102 reduce the variations of the torque and speeds of the power transmitting member 18 and second electric motor M2. In this case, too, the first-power-source torque-variation reducing portion 100 permits the drive force control of the engine 8, and the third-power-source torque-variation reducing portion 102 permits the drive force control of the second electric motor M2. It will be understood that the discharging control of the electric-energy storage device 56 involving an operation of the second electric motor M2 is another control which is implemented depending upon the running state of the vehicle and which causes a torque variation of the vehicle drive system.

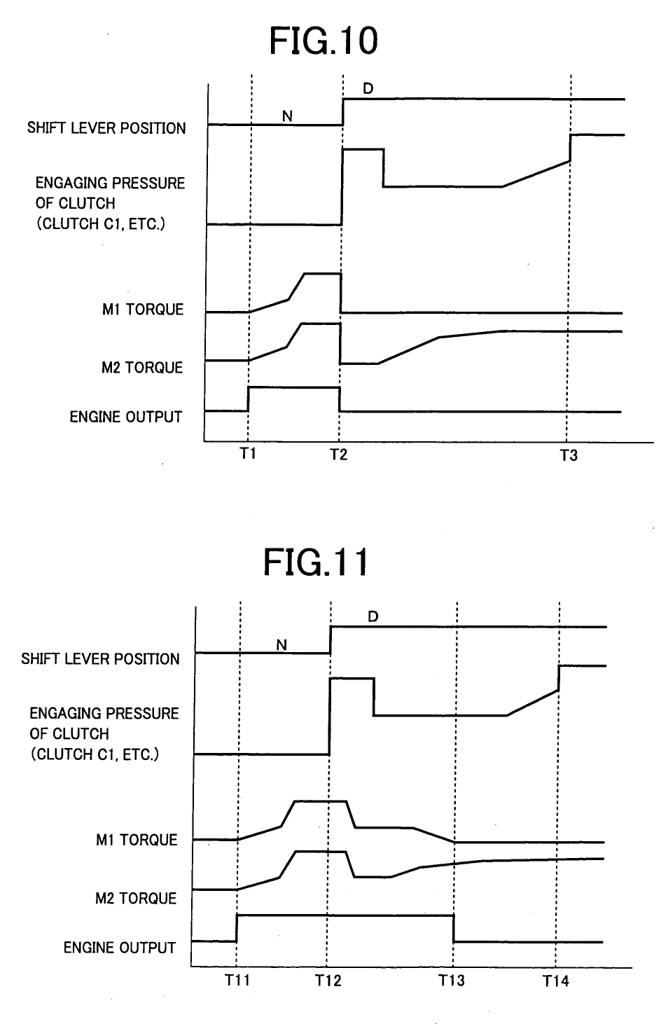

Referring to the time charts of FIGS. 10 and 11, there are indicated changes of the parameters relating to the starting controls of the engine 8 upon the N-to-D shifting operation of the shift lever 52, as examples of the control operations of the first-power-source torque-variation reducing portion 100 and the third-power-source torque-variation reducing portion 102. In the example of FIG. 10, the engine starting control is implemented while the accelerator pedal 74 is placed in the non-operated position (in the off state). In the example of FIG. 11, the engine starting control is implemented while the accelerator pedal 74 is placed in an operated position. In other words, the torque-variation reducing portion 101 is enabled to be operated in the example of FIG. 10 as a result of the affirmative determination by the accelerator-operation-amount determining portion 108. In the example of FIG. 11, the torque-variation reducing portion 101 is enabled to be operated as a result of the affirmative determination by the vehicle speed determining portion 106 while the negative determination is obtained by the accelerator-operation-amount determining portion 108.

In the example of FIG. 10, the engine 8 is operated for a time period from a point of time T1 to a point of time T2, for a warm-up purpose. In this time period, the output torques of the first and second electric motors M1, M2 are controlled. When the N-to-D shifting operation of the shift lever 52 is performed at the point of time T2, the first-power-source torque-variation reducing portion 100 stops the engine 8 even where the charging of the electric-energy storage device 55 by operation of the engine 8 becomes necessary due to reduction of the stored electric energy amount SOC below the lower limit. At the same time, the controls of the first and second electric motors M1, M2 are stopped. In a time period from the point of time T2 to a point of time T3, the first clutch C1 (and third rake B3) for establishing the first gear position, for example, is engaged. In this case, the vehicle is driven by the second electric motor M2, while the drive force control of the second electric motor M2 is permitted by the third-power-source torque-variation reducing portion 102, so that the output torque of the second electric motor M2 is gradually increased.

In the example of FIG. 11, the engine 8 is operated for a time period from a point of time T11 to a point of time T12, for a warm-up purpose. In this time period, the output torques of the first and second electric motors M1, M2 are controlled. Upon the N-to-D shifting operation, the determining portions 104, 106, 108, 112 are operated to determine whether the torque-variation reducing portion 101 should be enabled to be operated. Since the negative determination is obtained by the accelerator-operation-amount determining portion 108, the first-power-source torque-variation reducing portion 100 permits continuation of the operation of the engine 8, and the controls of the first and second electric motors M1, M2 are continued. When the first clutch C1 of the automatic transmission portion 20 has been fully engaged and its engaging pressure has been stabilized at a point of time T13, the engine 8 is stopped. At a point between the point of time T13 and a point of time T14, the engaging pressures of the first clutch C1 and third brake B3 are raised from the stabilized level for preventing slipping actions of the first clutch and third brake.

The flow chart of FIG. 12 illustrates a control routine executed by the electronic control device 80 upon the N-to-D shifting operation, to reduce a shock which would-take place due to a variation of the input torque of the automatic transmission portion 20. This control routine is repeatedly executed with an extremely short cycle time from about several milliseconds to several tens of milliseconds.

The control routine is initiated with step S1 corresponding to the clutch pressure determining portion 104, to determine whether the engaging pressure PC1 of the first clutch C1 is held within the predetermined range, that is, whether the first clutch C1 is in the process of an engaging action. If the negative determination is obtained in step S1, the control flow goes to step S7 in which controls other than the controls for reducing the torque variation are implemented.

If the affirmative determination is obtained in step S1, the control flow goes to step S2 corresponding to the vehicle speed determining portion 106, to determine whether the present vehicle speed V is lower than the predetermined threshold value. If a negative determination is obtained in step S2, the control flow goes to step S4 corresponding to the accelerator-operation-amount determining portion 108, to determine whether the operation amount A_{CC} of the accelerator pedal 74 is smaller than the predetermined threshold value. If the negative determination is obtained in step S4, the control flow goes to step S5 corresponding to the brake operation determining portion 112, to determine whether the brake switch 76 is placed in the off state, or whether the master cylinder pressure is lower than the predetermined threshold value. If a negative determination is obtained in step S5, the control flow goes to step S6 in which the torque-variation reducing portion 101 is disabled to be operated, so that the starting and stopping controls of the engine 8, and the charging and discharging controls are normally performed, without reducing the torque variations of the engine 8 and the second electric motor M2, for example.

If the affirmative determination is obtained in step S2, S4 or S5, the control flow goes to step S3 corresponding to the first-power-source and third-power-source torque-variation reducing portions 100, 102, to inhibit the controls of the engine 8 and the second electric motor M2 that causes the torque variations. Accordingly, the torque and speed variations of the power transmitting member 18 are reduced to reduce the engaging shock of the first clutch C1.

In the present embodiment of this invention described above, the first-power-source torque-variation reducing portion 100 is provided to reduce the amount of variation of the torque of the first drive power source in the form of the engine 8 upon the N-to-D shifting operation of the shift leer 52, so that the amount of variation of the rotating speed of the power transmitting member 18 due to the torque variation of the engine 8 upon the N-to-D shifting operation can be effectively reduced, and the engaging shocks of the frictional coupling devices (e.g., first clutch C1 and third brake B3) for the N-to-D shifting operation can be reduced.

The present embodiment is further arranged such that the amount of variation of the torque of the engine 8 from the target value is reduced, so that an amount of variation of the rotating speed of the power transmitting member 18 of the electrically controlled differential portion 11 due to the torque variation of the engine 8 upon switching of the N-to-D shifting operation of the shift lever 52 can be effectively reduced, and the engaging shocks of the frictional coupling devices for the N-to-D shifting operation can be reduced.

The present embodiment is further provided with the third-power-source torque-variation reducing portion 102 configured to reduce the amount of variation of the torque of the third drive power source in the form of the second electric motor M2 upon the N-to-D shifting operation of the shift leer 52, so that the amount of variation of the rotating speed of the power transmitting member 18 due to the torque variation of the second electric motor M2 upon the N-to-D shifting operation can be effectively reduced, and the engaging shocks of the frictional coupling devices for the N-to-D shifting operation can be reduced.

The present embodiment is further arranged such that the amount of variation of the torque of the second electric motor M2 from the target value is reduced, so that an amount of variation of the rotating speed of the power transmitting member 18 of the electrically controlled differential portion 11 due to the torque variation of the second electric motor M2 upon switching of the N-to-D shifting operation of the shift lever 52 can be effectively reduced, and the engaging shocks of the frictional coupling devices for the N-to-D shifting operation can be reduced.

The present embodiment is further arranged such that any control of the transmission mechanism 10 which is implemented depending upon the running state of the vehicle and which causes the torque variation of the transmission mechanism 10 is inhibited, so that the amount of the torque variation of the transmission mechanism can be reduced, and the engaging shocks of the frictional coupling devices in the process of the N-to-D shifting operation can be reduced.

The present embodiment is further arranged such that the control of the vehicle drive force produced by the first drive power source is permitted by the first-power-source torque-variation reducing portion 100 even in the process of the N-to-D shifting operation of the shift lever 52, so that the torque of the engine 8 is controlled to the target value while the amount of the torque variation of the engine 8 is reduced.

The present embodiment is further arranged such that the control of the vehicular drive system that causes a torque variation of the vehicular drive system is permitted by the third-power-source torque-variation reducing portion 1-2 to be continued if this control has already been initiated prior to an operation of the third-power-source torque-variation reducing portion 102. The continuation of the control makes it possible to prevent the torque variation of the vehicular drive system which would otherwise take place due to stopping of the control in the process of the N-to-D shifting operation.

The present embodiment is further arranged such that the third-power-source torque-variation reducing portion 102 is configured to permit a control of the drive force produced by the second electric motor M2 upon the N-to-D shifting operation, so that the torque of the second electric motor M2 is controlled to a target value while the amount of variation of the torque is reduced.

The present embodiment is further arranged such that the control of the vehicular drive system that causes a torque variation of the vehicular drive system is permitted by the first-power-source torque-variation reducing portion to be continued if this control has already been initiated prior to an operation of the first-power-source torque-variation reducing portion. The continuation of the control makes it possible to prevent the torque variation of the vehicular drive system which would otherwise take place due to stopping of the control in the process of the switching of the power transmitting path from the power cut-off state to the power transmitting state.

The present embodiment is further arranged such that at least one of the starting and stopping controls of the engine 8, and the charging and discharging controls of the electric-energy storage device 56 is inhibited in the process of the N-to-D shifting operation, so that the amount of variation of the torque of the engine.

The present embodiment is further arranged such that when the predetermined operation is performed by the vehicle operator, for example, when the vehicle operator operates the accelerator pedal 74, desiring to accelerate the vehicle, rapid acceleration of the vehicle as a result of the N-to-D shifting operation of the shift lever 52 is more important than reduction of the engaging shocks of the frictional coupling devices for the 4 N-to-D shifting operation. In this case, the above-indicated control of the vehicular drive system that causes the torque variation is not inhibited.

The present embodiment is further arranged such that the above-indicated control of the vehicular drive system which is implemented depending upon the vehicle running state and which causes the torque variation of the first drive power source is not inhibited if the vehicle accelerating member or brake operating member is operated by the vehicle operator, so that the vehicle is accelerated or braked as desired by the vehicle operator. When the vehicle accelerating member in the form of the accelerator pedal 74 is operated by more than a predetermined amount, the vehicle is rapidly accelerated as a result of the operation of the accelerator pedal 74. When the vehicle braking member in the form of the foot brake pedal 78 is operated, the vehicle is rapidly decelerated as a result of the operation of the foot brake pedal 78.

The present embodiment is further arranged such that the above-indicated control of the transmission mechanism 10 that causes the torque variation of the transmission mechanism 10 is implemented if the running state of the vehicle satisfies a predetermined condition. That is, the control that causes the torque variation is more important than reduction of the switching shock upon the N-to-D shifting operation.

The present embodiment is further arranged such that the above-indicated control of the transmission mechanism 10 that causes the torque variation of the transmission mechanism 10 is implemented if the vehicle running speed V is higher than the predetermined threshold, if the hydraulic pressure of the frictional coupling devices for the N-to-D shifting operation is outside the predetermined range, or if the drive force generated by the engine 8 is larger than the predetermined threshold. In this case, the control that causes the torque variation of the transmission mechanism 10 is more important than reduction of the switching shock.

The present embodiment is further arranged such that the electrically controlled differential portion 11 is operable as the continuously-variable transmission mechanism when the operating state of the first electric motor M1 is controlled, so that the vehicle drive torque can be smoothly changed. It is noted that the electrically controlled differential portion 11 is operable not only as an electrically controlled continuously-variable transmission the speed ratio of which is continuously variable, but also as a step-variable transmission the speed ratio of which is variable in steps, so that an overall speed ratio of the vehicular drive system can be rapidly changed in steps, whereby the vehicle drive torque can be rapidly changed.

Another embodiment of this invention will be described. The same reference signs as used in the first embodiment will be used in the following description to identify the same elements.

### Second Embodiment

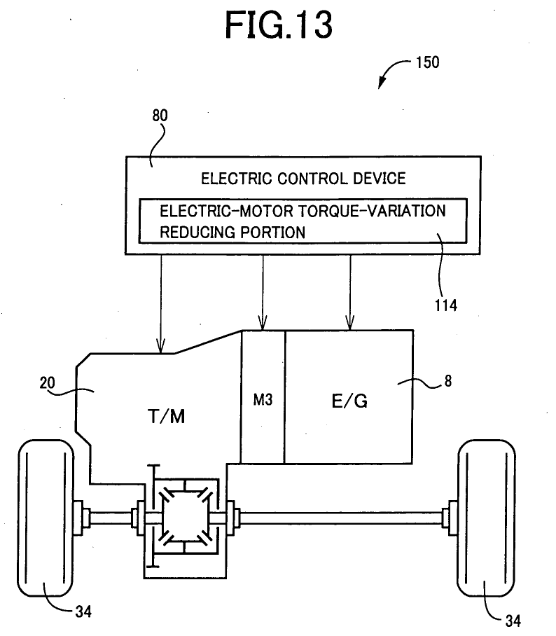

Referring next to the schematic view of FIG. 13, there is shown an arrangement of a transmission mechanism 150 which is controlled by a control apparatus in the form of the electronic control device 80 constructed according to the second embodiment of the present invention. In this transmission mechanism 150, the engine 8 is connected to an electric motor M3 ether directly or indirectly through a clutch device. The electric motor M3 is connected to the drive wheels 34 through the automatic transmission portion 20. A resistance to a rotary motion of the engine 8 can be reduced by closing intake valves, for efficient operation of the electric motor M3 as an electric generator to regenerate an electric energy. It will be understood that the electric motor M3 corresponds to an electric motor which is controlled by an electric-motor-torque reducing portion 114 of the electronic control device 80, which will be described.

The electric motor M3 of the transmission mechanism 150 is operated to drive the vehicle in a low-load running state with the engine 8 held at rest. To drive the vehicle in a high-load running state, only the engine 8 is operated as a drive power source, or the electric motor M3 is operated as an assisting drive power source to produce an assisting vehicle drive torque to assist the engine 8 operated as a main drive power source. The electric motor M3 is operated as the electric generator by a kinetic energy of the running vehicle, to decelerate the vehicle and to convert the kinetic energy into an electric energy.

Thus, the electric motor M3 is operatively connected to a power transmitting path between the engine 8 and the drive wheels 34. The electronic control device 80 provided to control the transmission mechanism 150 includes the electric-motor-torque reducing portion 114 indicated above, which is configured to reduce an amount of variation of the output torque of the electric motor M3, which would take place upon switching of the power transmitting path from the power cut-off state to the power transmitting state. The electric-motor-torque reducing portion 114 has the same function as the third-power-source torque-variation reducing portion 102 of the torque-variation reducing portion 101 described above, and will not be described.

The present embodiment is further arranged such that the electric-motor torque-variation reducing portion 114 is provided to reduce the amount of variation of the torque of the electric motor M3 when the power transmitting path is switched from the power cut-off state to the power transmitting state, so that an amount of variation of the rotating speed of the power transmitting member 18 due to the torque variation of the electric motor M3 upon switching of the power transmitting path from the power cut-off state to the power transmitting state can be effectively reduced, and a switching shock of the power transmitting path can be reduced.

The present embodiment is further arranged such that the control of the vehicular drive system which is implemented depending upon the vehicle running state and which causes the torque variation of the vehicular drive system is inhibited by the electric-motor torque-variation reducing portion 114, so that the amount of torque variation is reduced, and the switching shock is reduced.

The present embodiment is further arranged such that the electric-motor torque-variation reducing portion 114 permits the control of the drive force produced by the electric motor M3 upon the N-to-D shifting operation, so that the torque of the electric motor M3 is controlled to a target value while the amount of variation of the torque is reduced.

While the preferred embodiments of this invention have been described in detail by reference to the accompanying drawings, it is to be understood that the present invention may be otherwise embodied.

The illustrated embodiment is arranged such that the torque-variation reducing portion 101 is operated depending upon results of the determinations by the clutch pressure determining portion 104, vehicle speed determining portion 106, accelerator-operation-amount determining portion 108 and brake-operation determining portion 112. However, this arrangement is not essential. For instance, the operation of the torque-variation reducing portion 101 may also depend upon a result of a determination by a throttle-opening determining portion configured to determine whether the angle of opening θ_{TH} of the electronic throttle valve 62 is smaller than a predetermined threshold value. Further, all of the determining portions 104, 106, 108, 112 provided in the illustrated embodiment need not be used, and only selected ones of those four determining portions may be used. For example, only the clutch pressure determining portion 104 and the accelerator-operation-amount determining portion 108 may be used.

In the illustrated transmission mechanism 10, the second electric motor M2 is connected directly to the power transmitting member 18. However, the second electric motor M2 may be connected to any portion of the power transmitting path between the differential portion 11 and the drive wheels 34, either directly or indirectly through a suitable transmission device.

Although the differential portion 11 functions as an electrically controlled continuously variable transmission the gear ratio γ0 of which is continuously variable from the minimum value γ0ₘᵢₙ to the maximum value γ0ₘₐₓ, the differential portion 11 may be modified such that its speed ratio γ0 is not variable continuously, but is variable in steps by utilizing its differential function. The present invention is applicable to a hybrid vehicle drive system including the differential portion modified as described above.

Further, the differential portion 11 in the illustrated transmission mechanism 10 may be provided with a differential limiting device which is incorporated in the power distributing mechanism 16 and which is operable as a step-variable transmission having two forward-drive positions by limiting the differential function of the differential portion 11.

In the power distributing mechanism 16 in the illustrated transmission mechanism 10, the first carrier CA1 is fixed to the engine 8, and the first sun gear S1 is fixed to the first electric motor M1 while the first ring gear R1 is fixed to the power distributing member 18. However, this arrangement is not essential. The engine 8, first electric motor M1 and power transmitting member 18 may be fixed to any other elements selected from the three elements CA1, S1 and R1 of the first planetary gear set 24.

While the engine 8 is directly fixed to the input shaft 14 in the illustrated transmission mechanism 10, the engine 8 may be operatively connected to the input shaft 14 through any suitable member such as gears and a belt, and need not be disposed coaxially with the input shaft 14.

The hydraulically operated frictional coupling devices such as the first and second clutches C1, C2 in the illustrated transmission mechanism 10 may be replaced by coupling devices of magnetic powder type, electromagnetic type and mechanical type, such as powder clutches, electromagnetic clutches, meshing-type dog clutches. Where the electromagnetic clutches are used, the switching valve devices incorporated in the hydraulic control unit 70 are replaced by a switching device for controlling electric control signals for selectively energizing and de-energizing solenoids of the electromagnetic clutches, for example.

In the illustrated transmission mechanism 10, the first and second electric motors M1, M2 are disposed coaxially with the input shaft 14 such that the first electric motor M1 is connected to the first sun gear S1 while the second electric motor M2 is connected to the power transmitting member 18. However, this arrangement is not essential. For instance, the first electric motor M1 may be operatively connected to the first sun gear S1 through gears, a belt or a speed reduction device, while the second electric motor M2 may be connected to the power transmitting member 18.

In the illustrated embodiment, the automatic transmission portion 20 is connected in series to the differential portion 11 through the power transmitting member 18. However, the automatic transmission portion 20 may be disposed coaxially with a counter shaft disposed parallel to the input shaft 14. In this case, the differential portion 11 and the automatic transmission portion 20 are connected to each other through a suitable power transmitting member or members in the form of a pair of counter gears, or sprockets and a chain, such that a rotary motion can be transmitted between the differential portion 11 and the automatic transmission portion 20.

Further, the differential mechanism in the form of the power distributing mechanism 16 provided in the illustrated embodiment may be replaced by a differential gear device including a pinion rotated by the engine 8, and a pair of bevel gears which mesh with the pinion and which are operatively connected to the first electric motor M1 and the power transmitting member 18 (second electric motor M2).

While the power distributing mechanism 16 in the illustrated embodiment is constituted by one planetary gear set 24, it may be constituted by two or more planetary gear sets so that the power distributing mechanism 16 is operable as a transmission having three or more gear positions in the non-differential state (fixed-speed-ratio shifting state). The planetary gear sets are not limited to the single-pinion type, and may be of a double-pinion type. Where the power distributing mechanism 16 is constituted by two ore more planetary gear sets, the engine 8, first and second electric motors M1, M2 and power transmitting member 18 are operatively connected to respective rotary elements of the planetary gear sets, and the power distributing mechanism 16 is switched between its step-variable and continuously-variable shifting states, by controlling the clutches C and brakes B connected to the respective rotary elements of the planetary gear sets.

While the engine 8 and the differential portion 11 are connected directly to each other in the illustrated transmission mechanism 10, they may be connected to each other indirectly through a clutch.

In the illustrated transmission mechanism 10, the differential portion 11 and the automatic transmission portion 20 are connected in series to each other. However, the control apparatus according to the present invention is equally applicable to a drive system in which an electrically controlled differential portion and a step-variable transmission portion are not mechanically independent of each other, provided the drive system as a whole has an electric differential function, and a shifting function different from the electric differential function. Further, the electrically controlled differential portion and the step-variable transmission portion may be suitably disposed in a desired order in the drive system. Further, the principle of the present invention is applicable to any vehicular transmission mechanism having both an electric differential function and a speed-ratio changing function, which functions are performed by respective two mechanisms, a single common mechanism, or two mechanisms which cooperate to perform the electric differential function and/or the speed-ratio changing function.

It is to be understood that the embodiment of the invention has been described for illustrative purpose only, and that the present invention may be embodied with various changes and modifications which may occur to those skilled in the art.

What is claimed is:

1. A control apparatus for a vehicular drive system including (a) a first drive power source, (b) an electrically controlled differential portion which has a differential mechanism and a second drive power source connected to a rotary element of the differential mechanism and which is operable to control a differential state between a rotating speed of its input shaft connected to the first drive power source and a rotating speed of its output shaft by controlling an operating state of the second drive power source, and (c) a switching portion operable to switch a power transmitting path between the electrically controlled differential portion and a drive wheel of a vehicle, between a power transmitting state and a power cut-off state, said control apparatus comprising:
a first-power-source torque-variation reducing portion configured to reduce an amount of variation of a torque of the first drive power source upon switching of said power transmitting path from the power cut-off state to the power transmitting state.

2. The control apparatus according to claim 1, wherein the first-power-source torque-variation reducing portion is configured to reduce the amount of variation of the torque of the first drive power source from a target value.

3. The control apparatus according to claim 2, wherein the first power-source torque-variation reducing portion is configured to permit a control of a vehicle drive force produced by the first drive power source in the process of the switching of said power transmitting path.

4. The control apparatus according to claim 1, wherein the first-power-source torque-variation reducing portion is configured to inhibit a control of the vehicular drive system which is implemented depending upon a running state of the vehicle and which causes a torque variation of the vehicular drive system.

5. The control apparatus according to claim 4, wherein the first-power-source torque-variation reducing portion is configured to permit continuation of a control of the vehicular drive system that causes a torque variation of the vehicular drive system if said control has already been initiated prior to an operation of the first-power-source torque-variation reducing portion.

6. The control apparatus according to claim 4, wherein said control of the vehicular drive system which is implemented depending upon the running state of the vehicle and which causes the torque variation of the vehicular drive system is at least one of a starting control of said first drive power source, a stopping control of the first drive power source, a charging control of an electric-energy storage device by an electric generator connected to said first drive power source, and a discharging control of the electric-energy storage device.

7. The control apparatus according to claim 4, wherein the first-power-source torque-variation reducing portion is configured not to inhibit said control of the vehicular drive system which is implemented depending upon the running state of the vehicle and which causes the torque variation of the vehicular drive system, if a predetermined operation is performed by an operator of the vehicle.

8. The control apparatus according to claim 7, wherein said predetermined operation performed by the operator of the vehicle is an operation of a vehicle accelerating member to accelerate the vehicle or an operation of a brake operating member.

9. The control apparatus according to claim 4, wherein the first-power-source torque-variation reducing portion is configured not to inhibit said control of the vehicular drive system which is implemented depending upon the running state of the vehicle and which causes the torque variation of the vehicular drive system, if the running state of the vehicle satisfies a predetermined condition.

10. The control apparatus according to claim 9, wherein the running state of the vehicle which satisfies the predetermined condition is a running speed of the vehicle higher than a predetermined threshold, a hydraulic pressure of said switching portion outside a predetermined range, or a drive force larger than a predetermined threshold, which is generated by said first drive power source.

11. The control apparatus according to claim 1, wherein the electrically controlled differential portion is operable as a continuously-variable transmission mechanism when the operating state of said second drive power source is controlled.

12. The control apparatus according to claim 1, wherein the first drive power source is an engine.

13. The control apparatus according to claim 1, wherein the second drive power source is a first electric motor operated with an electric energy.

14. A control apparatus for a vehicular drive system including (a) a first drive power source, (b) an electrically controlled differential portion which has a differential mechanism and a second drive power source connected to a rotary element of the differential mechanism and which is operable to control a differential state between a rotating speed of its input shaft connected to the first drive power source and a rotating speed of its output shaft by controlling an operating state of the second drive power source, (c) a switching portion operable to switch a power transmitting path between the electrically controlled differential portion and a drive wheel of a vehicle, between a power transmitting state and a power cut-off state, and (d) a third drive power source operatively connected to a portion of said power transmitting path, said control apparatus comprising:
a third-power-source torque-variation reducing portion configured to reduce an amount of variation of a torque of said third drive power source upon switching of the power transmitting path from the power cut-off state to the power transmitting state.

15. The control apparatus according to claim 14, wherein the third-power-source torque-variation reducing portion is configured to inhibit a control of the vehicular drive system which is implemented depending upon a running state of the vehicle and which causes a torque variation of the vehicular drive system.

16. The control apparatus according to claim 15, wherein the third-power-source torque-variation reducing portion is configured to permit a control of a drive force produced by the third drive power source in the process of the switching of said power transmitting path.

17. The control apparatus according to claim 15, wherein the third-power-source torque-variation reducing portion is configured to permit continuation of a control of the vehicular drive system that causes a torque variation of the vehicular drive system if said control has already been initiated prior to an operation of the first-power-source torque-variation reducing portion.

18. The control apparatus according to claim 15, wherein said control of the vehicular drive system which is implemented depending upon the running state of the vehicle and which causes the torque variation of the vehicular drive system is at least one of a starting control of said first drive power source, a stopping control of the first drive power source, a charging control of an electric-energy storage device by an electric generator connected to said first drive power source, and a discharging control of the electric-energy storage device.

19. The control apparatus according to claim 15, wherein the third-power-source torque-variation reducing portion is configured not to inhibit said control of the vehicular drive system which is implemented depending upon the running state of the vehicle and which causes the torque variation of the vehicular drive system, if a predetermined operation is performed by an operator of the vehicle.

20. The control apparatus according to claim 19, wherein said predetermined operation performed by the operator of the vehicle is an operation of a vehicle accelerating member to accelerate the vehicle or an operation of a brake operating member.

21. The control apparatus according to claim 15, wherein the third-power-source torque-variation reducing portion is configured not to inhibit said control of the vehicular drive system which is implemented depending upon the running state of the vehicle and which causes the torque variation of the vehicular drive system, if the running state of the vehicle satisfies a predetermined condition.

22. The control apparatus according to claim 21, wherein the running state of the vehicle which satisfies the predetermined condition is a running speed of the vehicle higher than a predetermined threshold, a hydraulic pressure of said switching portion outside a predetermined range, or a drive force larger than a predetermined threshold, which is generated by said first drive power source.

23. The control apparatus according to claim 14, wherein the electrically controlled differential portion is operable as a continuously-variable transmission mechanism when the operating state of said second drive power source is controlled.

24. The control apparatus according to claim 14, wherein the first drive power source is an engine.

25. The control apparatus according to claim 14, wherein the second drive power source is a first electric motor operated with an electric energy.

26. The control apparatus according to claim 14, wherein the third drive power source is a second electric motor operated with an electric energy.

27. A control apparatus for a vehicular drive system including (a) a first drive power source, (b) a switching portion operable to switch a power transmitting path between the first drive power source and a drive wheel of a vehicle, between a power transmitting state and a power cut-off state, and (c) an electric motor operatively connected to a portion of said power transmitting path, said control apparatus comprising:
an electric-motor torque-variation reducing portion configured to reduce an amount of variation of said electric motor upon switching of said power transmitting path from the power cut-off state to the power transmitting state.

28. The control apparatus according to claim 27, wherein the electric-motor torque-variation reducing portion is configured to inhibit a control of the vehicular drive system which is implemented depending upon a running state of the vehicle and which causes a torque variation of the vehicular drive system.

29. The control apparatus according to claim 28, wherein the electric-motor torque-variation reducing portion is configured to permit a control of a drive force produced by the electric motor in the process of the switching of said power transmitting path.

30. The control apparatus according to claim 28, wherein the electric-motor torque-variation reducing portion is configured to permit continuation of a control of the vehicular drive system that causes a torque variation of the vehicular drive system if said control has already been initiated prior to an operation of the electric-motor torque-variation reducing portion.

31. The control apparatus according to claim 28, wherein said control of the vehicular drive system which is implemented depending upon the running state of the vehicle and which causes the torque variation of the vehicular drive system is at least one of a starting control of said first drive power source, a stopping control of the first drive power source, a charging control of an electric-energy storage device by an electric generator connected to said first drive power source, and a discharging control of the electric-energy storage device.

32. The control apparatus according to claim 28, wherein the electric-motor torque-variation reducing portion is configured not to inhibit said control of the vehicular drive system which is implemented depending upon the running state of the vehicle and which causes the torque variation of the vehicular drive system, if a predetermined operation is performed by an operator of the vehicle.

33. The control apparatus according to claim 32, wherein said predetermined operation performed by the operator of the vehicle is an operation of a vehicle accelerating member to accelerate the vehicle or an operation of a brake operating member.

34. The control apparatus according to claim 28, wherein the electric-motor torque-variation reducing portion is configured not to inhibit said control of the vehicular drive system which is implemented depending upon the running state of the vehicle and which causes the torque variation of the vehicular drive system, if the running state of the vehicle satisfies a predetermined condition.

35. The control apparatus according to claim 34, wherein the running state of the vehicle which satisfies the predetermined condition is a running speed of the vehicle higher than a predetermined threshold, a hydraulic pressure of said switching portion outside a predetermined range, or a drive force larger than a predetermined threshold, which is generated by said first drive power source.

36. The control apparatus according to claim 28, wherein the first drive power source is an engine.
